(19) United States
(12) Patent Application Publication
(10) Pub. No.: US 2026/0283768 A1
(43) Pub. Date: Sep. 24, 2026

(54) Powered Oral Care Implement

(71) Applicant: Colgate-Palmolive Company, New York, NY (US)

(72) Inventors: Brian BLOCH, Hillsborough, NJ (US); Robert FOX, Hazlet, NJ (US); Thuan Chong TAn, Shanghai (CN); Youliang WANG, Ganzhou City (CN); Liping GU, Shanghai (CN)

(73) Assignee: Colgate-Palmolive Company, New York, NY (US)

(21) Appl. No.: 19/469,115

(22) PCT Filed: Mar. 31, 2023
(86) PCT No.: PCT/CN2023/085298

§ 371 Date: Sep. 25, 2025

(51) Int. Cl. A61C 17/22

(52) U.S. Cl. CPC A61C 17/221; A61C 17/225

(57) ABSTRACT

A powered oral care implement may include a handle and a refill head. The handle may define a cavity. A motor and a chassis may be located in the cavity. A battery may be located within a receptacle of the chassis. An end cap may be coupled to the chassis or the handle to close an opening in a bottom end of the handle. A first electrical conductor element may be coupled to the outer surface of the chassis to supply power from a first terminal of the battery to the motor. A switch may be used to supply power, intermittently, from a second terminal of the battery to the motor. An actuation assembly may exist to allow for altering the switch between open and closed states.

### BACKGROUND

Toothbrushes are used by people all over the world, typically twice a day. Other oral care implements, such as flosser devices, water jets, and the like are also used, although somewhat less frequently. As such, innovations in oral care devices are constantly being made to improve the experience for the user and to reduce costs for the manufacturer which can then be passed on to the consumer. Powered oral care implements that include a motor and other electronic components to facilitate movement of the cleaning elements are highly recommended by dentists for their improved cleaning performance. However, effective powered oral care implements come at a premium cost due to the increase in steps required for manufacture and the expense of the electronic components. Thus, a need exists for improvements in powered oral care implements that eases the manufacturability thereof and provides more flexibility for the end user.

### BRIEF SUMMARY

The present invention may be directed to a powered oral care implement capable of having either a non-functional end cap or a functional end cap, which can be swapped out as desired. The present invention may be directed to a powered oral care implement wherein the main rigid body thereof has a large front window opening for insertion of various electronic and mechanical components during manufacturing. The present invention may be directed to a powered oral care implement whereby elongated metal strips used as electrical conductor elements are attached to an outer surface of a chassis which defines a receptacle within which the battery is positioned.

In one aspect, the invention may be a powered oral care implement comprising: a handle comprising a gripping portion having a cavity that extends along a cavity axis from an open bottom end to a top end; a motor in the cavity adjacent to the top end of the cavity; a chassis in the cavity adjacent to the open bottom end of the cavity, the chassis comprising an outer surface and an inner surface that defines a receptacle; a battery configured to be positioned in the receptacle of the chassis; an end cap detachably coupled to the chassis or to the handle to close the open bottom end of the cavity, the end cap comprising a cap contact assembly that is electrically coupled to a first terminal of the battery; a first electrical conductor element coupled to the chassis and extending along the outer surface of the chassis, the first electrical conductor element comprising a first contact portion that is electrically coupled to the motor and a second contact portion that is in contact with the cap contact assembly to electrically couple the motor to the first terminal of the battery; a switch assembly located in the cavity and electrically coupled to a second terminal of the battery, the switch assembly being alterable between: (1) a closed state wherein the switch assembly is electrically coupled to the motor and the motor is powered; and (2) an open state wherein the switch assembly is not electrically coupled to the motor and the motor is not powered; and an actuation assembly on the outer surface of the handle for altering the switch assembly between the open and closed states.

In another aspect, the invention may be a powered oral care implement comprising: a handle comprising a gripping portion having a cavity that extends along a cavity axis from an open bottom end to a top end; a motor in the cavity adjacent to the top end of the cavity; a battery configured to be positioned in the cavity; an end cap configured to close the open bottom end of the cavity of the gripping portion of the handle, the end cap comprising a cap contact assembly that is electrically coupled to a first terminal of the battery, the cap contact assembly comprising a first cap contact element; a switch assembly located in the cavity and electrically coupled to a second terminal of the battery, the switch assembly being alterable between: (1) a closed state wherein the motor is electrically coupled to the second terminal of the battery; and (2) an open state wherein the motor is not electrically coupled to the second terminal of the battery; a first electrical conductor element located in the cavity and comprising a first contact portion that is electrically coupled to the motor and a second contact portion that is electrically coupled to the first terminal of the battery through contact with the first cap contact element of the end cap; and a second electrical conductor element located in the cavity, wherein the second electrical conductor element is electrically coupled to the second terminal of the battery when the switch is in the closed state and the second electrical conductor element is not electrically coupled to the second terminal of the battery when the switch is in the open state.

In another aspect, the invention may be a powered oral care implement comprising: a handle comprising a gripping portion having a cavity that extends along a cavity axis from an open bottom end to a top end; a motor in the cavity adjacent to the top end of the cavity; a battery configured to be positioned in the cavity; a switch assembly located in the cavity and comprising a fixed contact element that is electrically coupled to the motor and a switch element that is electrically coupled to a second terminal of the battery, the switch element being alterable between: (1) a first position wherein the switch element is in contact with the fixed contact element to electrically couple the motor to the second terminal of the battery; and (2) a second position wherein the switch element is not in contact with the fixed contact element and the motor is not electrically coupled to the second terminal of the battery; a first electrical conductor element located in the cavity and comprising a first contact portion that is electrically coupled to the motor and a second contact portion; a second electrical conductor element located in the cavity and comprising a first contact portion that is electrically coupled to the fixed contact element and a second contact portion; wherein the open bottom end of the cavity is configured to be closed by an end cap selected from a non-functional end cap and a functional end cap, wherein: the non-functional end cap comprises a cap contact assembly that is electrically coupled to a first terminal of the battery and the second contact portion of the first electrical conductor element without being electrically coupled to the second terminal of the battery; and the functional end cap comprises a functional element and a cap contact assembly operably coupled to the functional element, the cap contact assembly comprising a first cap contact element that electrically couples the functional element to the first terminal of the battery and a second cap contact element that is in contact with the second contact portion of the second electrical conductor element to electrically couple the functional element to the second terminal of the battery when the switch element is in the first position to power the functional element.

In yet another aspect, the invention may be a powered oral care implement comprising: a handle assembly comprising a handle comprising a gripping portion having a cavity that extends along a cavity axis from an open bottom end to a top end; a motor in the cavity adjacent to the top end of the cavity; a battery configured to be positioned in the cavity; a switch assembly located in the cavity and electrically coupled to a second terminal of the battery, the switch assembly being alterable between: (1) a closed state wherein the motor is electrically coupled to the second terminal of the battery; and (2) an open state wherein the motor is not electrically coupled to the second terminal of the battery; a first electrical conductor element located in the cavity and comprising a first contact portion that is electrically coupled to the motor and a second contact portion; and a non-functional end cap configured to close the open bottom end of the cavity, the non-functional end cap comprising: a cap housing comprising a sidewall and a retention element protruding radially outward form the sidewall; and a cap contact assembly coupled to the cap housing, the cap contact assembly comprising a spring contact element that is coupled to a first terminal of the battery and a first cap contact element protruding radially outward from the sidewall of the cap housing; and wherein the retention element and the first cap contact element are configured to engage the handle assembly to couple the non-functional end cap to the handle assembly, and wherein the first cap contact element is in contact with the second contact portion of the first electrical conductor element when the non-functional end cap is coupled to the handle assembly to electrically couple the motor to the first terminal of the battery.

In still another aspect, the invention may be a powered oral care implement comprising: a handle assembly comprising a handle comprising a gripping portion having a cavity that extends along a cavity axis from an open bottom end to a top end; a motor in the cavity adjacent to the top end of the cavity; a battery configured to be positioned in the cavity; a switch assembly located in the cavity and electrically coupled to a second terminal of the battery, the switch assembly being alterable between: (1) a closed state wherein the motor is electrically coupled to the second terminal of the battery; and (2) an open state wherein the motor is not electrically coupled to the second terminal of the battery; a first electrical conductor element located in the cavity and comprising a first contact portion that is electrically coupled to the motor and a second contact portion; a second electrical conductor element located in the cavity and comprising a first contact portion that is coupled to the switch assembly and a second contact portion; a functional end cap configured to close the open bottom end of the cavity, the functional end cap comprising: a functional element configured to perform a function when powered; a cap housing; and a cap contact assembly coupled to the cap housing, the cap contact assembly comprising: a first cap contact element that is electrically coupled to a first terminal of the battery and is in contact with the second contact portion of the first electrical conductor element to electrically couple the motor to the first terminal of the battery; and a second cap contact element that is in contact with the second contact portion of the second electrical conductor element; and wherein the first and second cap contact elements are electrically coupled to the functional element so that the functional element is powered when the switch assembly is in the closed state.

In a further aspect, the invention may be a powered oral care implement comprising: a handle comprising a gripping portion that extends from a first end to a second end along a longitudinal axis, the gripping portion comprising: a rigid body portion defining a cavity, the rigid body portion comprising: a first axial portion comprising a body that surrounds a first portion of the cavity, the first axial portion comprising the first end of the gripping portion; and a second axial portion that extends from the first axial portion to the second end of the gripping portion, the second axial portion comprising a front opening that forms a passageway into a second portion of the cavity; a cover member bonded to the rigid body portion to close the front opening, the cover member comprising: a rigid cover portion comprising a front surface, a rear surface, and an opening extending from the front surface to the rear surface; and an elastomeric actuation portion coupled to the rigid cover portion to close the opening in the rigid cover portion; a motor, a power source, and a switch located in the cavity, wherein actuation of the elastomeric actuation portion of the cover member actuates the switch between an open state whereby the motor is not electrically coupled to the power source and a closed state whereby the motor is electrically coupled to the power source.

In a still further aspect, the invention may be a method of manufacturing a powered oral care implement, the method comprising: forming a handle comprising a gripping portion that extends from a first end to a second end along a longitudinal axis, the gripping portion comprising: a first axial portion defining a first portion of a cavity, the first axial portion comprising a bottom opening that forms a passageway into the first portion of the cavity; and a second axial portion defining a second portion of the cavity, the second axial portion comprising a front opening that forms a passageway into the second portion of the cavity; inserting a motor into the second portion of the cavity via the front opening, the motor comprising a first wire and a second wire; inserting a contact plate into the second portion of the cavity via the front opening and attaching the contact plate to the gripping portion; inserting a switch into the second portion of the cavity via the front opening and attaching the switch to the gripping portion; inserting a chassis assembly into the first portion of the cavity through the bottom opening, the chassis assembly comprising a chassis housing and a electrical conductor element coupled to an outer surface of the chassis housing; soldering a free end of the first wire to the contact plate; soldering a free end of the second wire to the electrical conductor element; attaching a cover member to the second axial portion of the gripping portion to close the front opening; and coupling an end cap to the handle or to the chassis housing to the close the opening in the first end of the gripping portion.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a front perspective view of a powered oral care implement in accordance with an embodiment of the present invention;

FIG. 2 is a rear perspective view of the powered oral care implement of FIG. 1;

FIG. 3 is a cross-sectional view taken along line III-III of FIG. 1;

FIG. 4 is a partially exploded front perspective view of the powered oral care implement of FIG. 1;

FIG. 5 is a partially exploded front perspective view of the powered oral care implement of FIG. 1;

FIG. 6 is a perspective view of a handle of the powered oral care implement of FIG. 1 with a cover member thereof exploded from a rigid body portion thereof;

FIG. 7 is a front view of the rigid body portion of the handle FIG. 6

FIG. 8A is a front perspective view of a chassis assembly of the powered oral care implement of FIG. 1 with electrical conductor elements thereof exploded from a chassis thereof;

FIG. 8B is a rear perspective exploded view of the chassis assembly of FIG. 8A;

FIG. 9A is a perspective view of an end cap of the powered oral care implement of FIG. 1 in accordance with an embodiment of the present invention;

FIG. 9B is an exploded perspective view of the end cap of FIG. 9A;

FIG. 10A is a front perspective view of an electronic assembly of the powered oral care implement of FIG. 1;

FIG. 10B is a rear perspective view of the electronic assembly of FIG. 10A;

FIG. 11 is a cross-sectional view taken along line XI-XI of FIG. 10A;

FIG. 12 is a close-up view of area XII of FIG. 3;

FIG. 13 is an exploded view of a powered oral care implement in accordance with an alternative embodiment of the present invention;

FIG. 14 is an exploded front perspective view of a chassis assembly of the powered oral care implement of FIG. 13;

FIG. 15A is a perspective view of an end cap of the powered oral care implement of FIG. 14 in accordance with an embodiment of the present invention;

FIG. 15B is an exploded perspective view of the end cap of FIG. 15A;

FIG. 16A is a front perspective view of an electronic assembly of the powered oral care implement of FIG. 14 using the end cap of FIG. 15A;

FIG. 17 is a cross-sectional view taken along line XVII-XVII of FIG. 16;

FIG. 18 is a perspective view of an end cap of the powered oral care implement of FIG. 14 in accordance with an alternative embodiment of the present invention;

FIG. 19 is an exploded perspective view of the end cap of FIG. 18;

FIG. 20 is a front perspective view of an electronic assembly of the powered oral care implement of FIG. 14 using the end cap of FIG. 18;

FIG. 21 is a cross-sectional view taken along line XXI-XXI of FIG. 20; and

FIG. 22 is a view of a powered oral care implement illustrating the either the end cap of FIG. 15A or the end cap of FIG. 18 may be used.

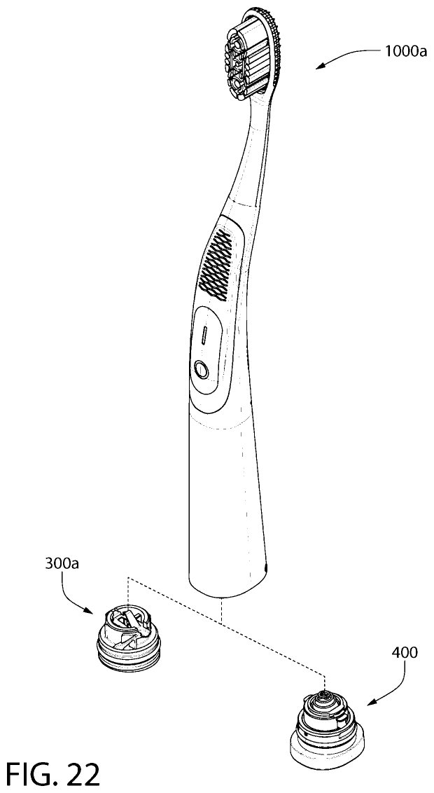

### DETAILED DESCRIPTION

The following description of the preferred embodiment(s) is merely exemplary in nature and is in no way intended to limit the invention, its application, or uses.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

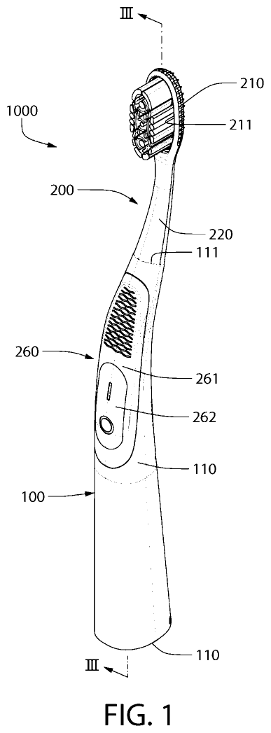

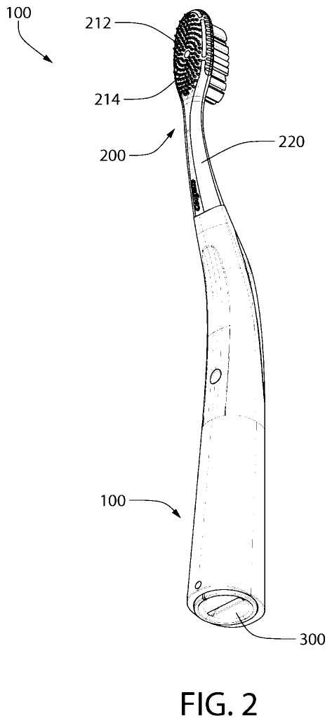

Referring to FIGS. 1-4, a powered oral care implement 1000 is illustrated in accordance with an exemplified embodiment of the present invention. The powered oral care implement generally comprises a handle 100, a refill head 200, and an end cap 300. The handle 100 generally comprises a gripping portion 110 that comprises a bottom end 111 and a top end 112 and a stem 113 that protrudes from the top end of the gripping portion 110. The gripping portion 110 may be the portion of the handle 100 that is gripped by a user to manipulate the powered oral care implement 1000 to perform its oral cleaning function during use. The stem portion 113 may be configured to mate or engage with the refill head 300 to facilitate a detachable attachment between the refill head 300 and the stem portion 113.

The refill head 200 may comprise a head portion 210 and a sleeve portion 220. The head portion 210 may comprise a front surface 211 and a rear surface 212 opposite the front surface 211. A plurality of cleaning elements 213 may be coupled to the head portion 210 and protrude from the front surface 211 of the head portion 210 for purposes of cleaning teeth. The cleaning elements 213 may be filament bristles, lamella, elastomeric elements, spiral bristles, bristle tufts, tapered bristles and tapered bristle tufts, and combinations thereof as is common for toothbrushes. A soft tissue cleaner 214 may be located on the rear surface 212 of the head portion 210. The soft tissue cleaner 214 may be formed from an elastomeric material and may be injection molded onto the rear surface 212 of the head portion 210.

The sleeve portion 220 may comprise a bottom end 221 having an opening 222 therein. The sleeve portion 220 may comprise an inner surface 223 that defines a sleeve cavity 224 that extends from the opening 222 towards the head portion 210. The inner surface 223 of the sleeve cavity 224 may comprise connection features (i.e., protrusions, notches, channels, ridges, or the like) that mate with corresponding connection features on the stem portion 113 of the handle 100 to facilitate the connection between the refill head 200 and the handle 100. When the refill head 200 is coupled to the handle 100, the stem portion 113 may nest within the sleeve cavity 224. A user may pull the refill head 200 away from the handle 100 with a force to separate the refill head 200 from the handle 100 to clean or replace the refill head 200 as needed.

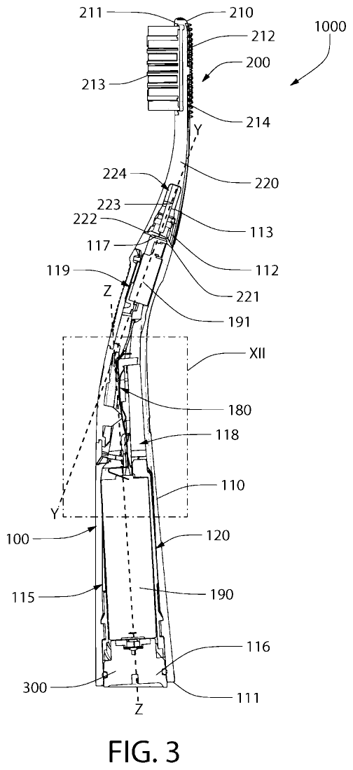

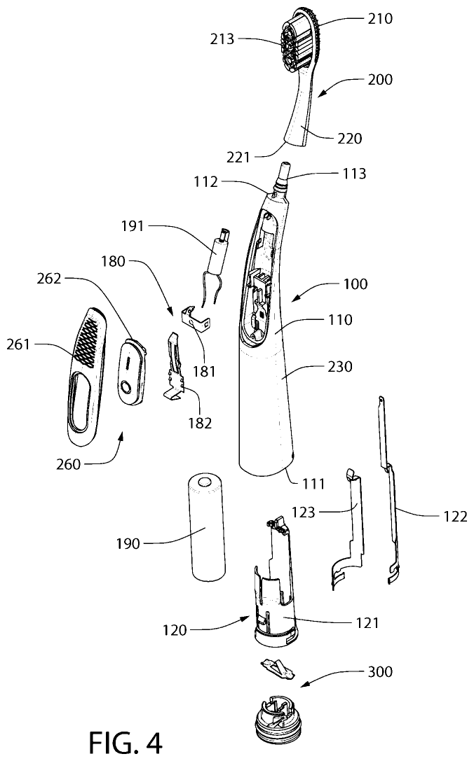

Referring specifically to FIGS. 3 and 4, additional features of the powered oral care implement 1000 will be described. The gripping portion 110 of the handle 100 comprises a cavity 115 that extends from an open bottom end which is formed by an opening 116 in the bottom end 111 of the gripping portion 110 to a top end 117. The cavity 115 extends from the open bottom end to the top end 117 along a cavity axis. There are several electronic and mechanical components which are located within the cavity 115 of the gripping portion 110 of the handle 100. This includes a chassis assembly 120 that comprises a chassis 121, a first electrical conductor element 122, a second electrical conductor element 123, a battery (or other power source) 190, a motor 191, and a switch assembly 180 which comprises a fixed contact element 181 and a switch element 182. In the exemplified embodiment, the motor 191 is positioned within the cavity 115 and located adjacent to the top end 117 of the cavity 115 near to the stem 113 so that vibrations generated by the motor 191 may be transmitted to the refill head 200 and the cleaning elements 213 thereof. The chassis 121 of the chassis assembly 120 is located in the cavity 115 adjacent to the open bottom end of the cavity 115. Further details about the aforementioned components will be provided below, including details about the components individually and their cooperative relationship and function.

In the exemplified embodiment, the gripping portion 110 of the handle 100 comprises a rigid body portion 230 and a cover member 260. The cover member 260 may comprise a rigid cover portion 261 and an elastomeric actuation portion 262. These features will be described in greater detail below.

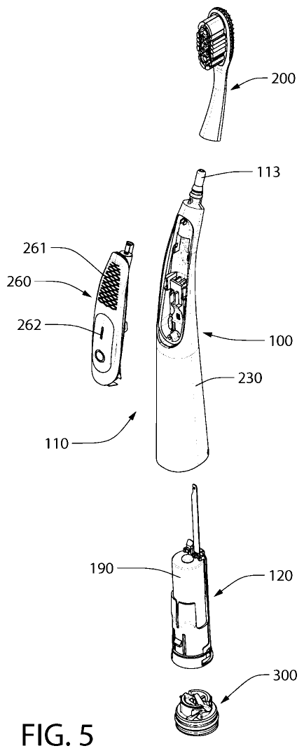

FIG. 5 illustrates the powered oral care implement 1000 with the refill head 200 detached from the handle 100, with the cover member 260 of the gripping portion 110 of the handle 100 exploded or detached from the rigid body portion 230 of the gripping portion 110 of the handle 100, with the chassis assembly 120 removed from the cavity 115 and with the battery 190 placed within the chassis assembly 120, and with the end cap 300 detached from the handle 100. During assembly, the chassis assembly 120 may be inserted into the cavity 115 through the open bottom end of the cavity 115, and then the end cap 300 may be coupled to the handle 100. Furthermore, the cover member 260 may be coupled to the rigid body portion 230 to finish the assembly.

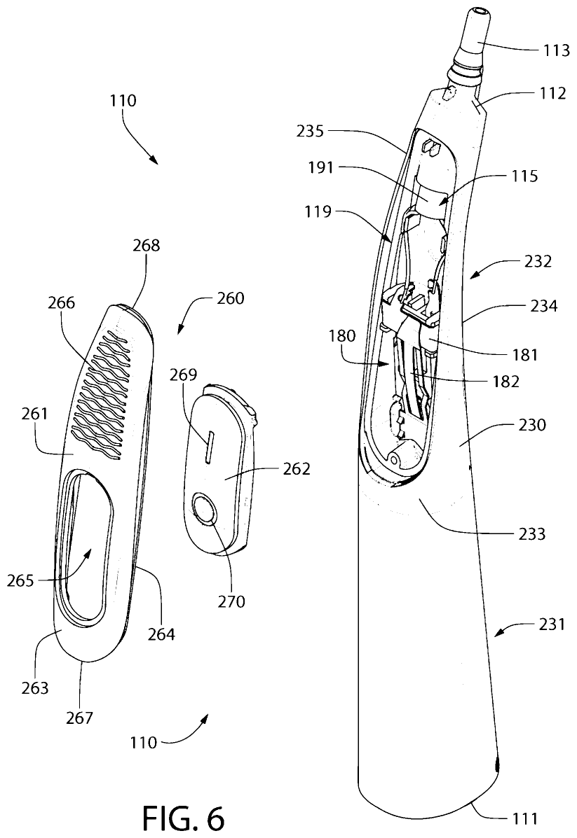

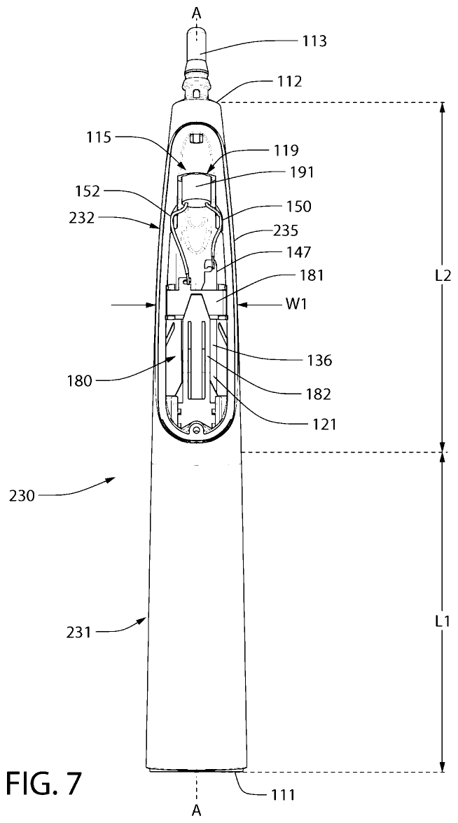

Referring to FIGS. 6 and 7, further details regarding the rigid body portion 230 and the cover member 260 of the gripping portion 110 of the handle 100 will be described. It should be noted that the stem 113 may be integrally formed with the rigid body portion 230. The rigid body portion 230 may define the cavity 115. The rigid body portion 230 may comprise a first axial portion 231 that comprises the bottom end 111 of the gripping portion 110 and a second axial portion 232 that extends from the first axial portion 232 to the top end 112 of the gripping portion 110.

In an embodiment, the first axial portion 231 may extend along a first axis Z-Z and the second axial portion 232 may extend along a second axis Y-Y. The second axis Y-Y may be angled relative to the first axis Z-Z. The first and second axes Z-Z, Y-Y may intersect at an oblique angle. In an embodiment, the second axial portion 232 may extend from the first axial portion 231 in an upward and rearward direction. This may result in a handle 100 with increased comfort and maneuverability for a user.

The first axial portion 231 may comprise a body that surrounds a first or lower portion 118 (labeled in FIG. 3) of the cavity 115. The first portion 118 of may be a first or lower axial portion of the cavity 115. The first axial portion 231 may be free of any openings with the exception of the opening in the bottom end 111. Sated another way, the body of the first axial portion 231 may comprise an inner surface that surrounds and defines the first portion 118 of the cavity 115 and an outer surface opposite the inner surface. The body of the first axial portion 231 may be free of any openings that extend from the outer surface to the inner surface. Thus, the opening in the bottom end 111 may form the only passageway directly into the first portion 118 of the cavity 115. The first axial portion 231 may comprise a cylindrical body, although the specific cross-sectional shape of the first axial portion 231 need not be round in all embodiments. The chassis assembly 120 and the battery 190 may be located within the first portion 118 of the cavity 115 when the handle 100 is fully assembled. The chassis assembly 120 and the battery 190 may be inserted into the first portion 118 of the cavity 115 through the opening in the bottom end 111 of the gripping portion 110 of the handle 100.

The second axial portion 232 may define a second or upper portion 119 of the cavity 115. The second or upper portion may be a second or upper axial portion of the cavity 115. The first and second portions of the cavity 115 may be continuous such that the first and second portions of the cavity 115 may be in fluid communication with one another. That is, the first and second portions 118, 119 of the cavity 115 may not be entirely separated from one another by a solid wall or the like, but instead certain elements or components may be positioned within both of the first and second portions of the cavity 115. For example, at least one of the first and second electrical conductor elements 122, 123 may be located in both of the first and second portions 115 of the cavity, as described in greater detail below.

The second axial portion 232 of the rigid body portion 230 of the gripping portion 110 may comprise a front opening 235 that forms a passageway directly into the second portion 119 of the cavity 115. The front opening 235 may be large and take up a substantial entirety of the length of the second axial portion 232 of the rigid body portion 230. As such, the motor 191 and the switch assembly 180, which are located within the second portion 119 of the cavity 115, may be inserted into the cavity 115 through the front opening 235. The second axial portion 232 of the rigid body 230 may comprise an outer surface comprising a front surface portion 233 and a rear surface portion 234, each extending approximately 180° around the rigid body portion 230. The front opening 235 may be located in the front surface portion 233 of the outer surface of the rigid body 230. The front opening 235 may have a width W1 which extends approximately an entirety of a width of the gripping portion 110 of the handle 100.

In the exemplified embodiment, the first axial portion 231 of the rigid body portion 230 of the gripping portion 110 of the handle 100 has a first length L1 and the second axial portion 232 of the rigid body portion 230 of the gripping portion 110 of the handle 100 has a second length L2. The first and second lengths L1, L2 may be the same, or one of the first and second lengths L1, L2 may be greater than the other. In an embodiment, the front opening 235 is elongated in a direction of the longitudinal axis A-A of the gripping portion 110 of the handle 100. The front opening 235 may have an oval shape, although other shapes may also be possible, such as rectangular. In an embodiment, the front opening 235 may extend along greater than 70% of the second length L2. In an embodiment, the front opening 235 may extend along greater than 90% of the second length. The gripping portion 110 of the handle 100 may have a third length which is equal to the sum of the first and second lengths L1, L2. In an embodiment, the front opening 235 may extend along between 40% and 60% of the length of the gripping portion 110 of the handle 100. The front opening 235 may also extend along a substantial entirety (between 95% and 100%) of the width of the gripping portion 110 of the handle 100.

The cover member 260 may be configured to be bonded to the rigid body portion 230 to close the front opening 235 in the second axial portion 232 of the rigid body portion 230. However, the cover member 260 may only be bonded to the rigid body portion 230 after the motor 191, the switch assembly 180, and any other desired components are inserted into the second portion 119 of the cavity 115 through the front opening 235. That is, after forming the rigid body portion 230 of the handle 100, the motor 191 and the switch assembly 180 may be assembled into the cavity 115 and attached to the rigid body portion 230 through the front opening 235. After this assembly is completed, the cover member 260 may be coupled to the rigid body portion 230 to close the front opening 235. As noted above, the cover member 260 may comprise the rigid cover portion 261 and the elastomeric actuation portion 262. The rigid body portion 230 and the rigid cover portion 261 may be formed from a hard plastic material whereas the elastomeric actuation portion 262 may be formed from an elastomeric material.

The rigid cover portion 261 of the cover member 260 may comprise a front surface 263 and a rear surface 264 opposite the front surface 263. The rigid cover portion 261 may further comprise an opening 265 extending from the front surface 263 to the rear surface 264. The opening 265 may be round or oval, although the invention is not to be so limited and other shapes may be used. In the exemplified embodiment the opening 265 is oval and elongated in a direction of the longitudinal axis A-A. The front surface 263 of the rigid cover portion 261 may comprise a textured region 266. The front surface 263 of the rigid cover portion 261 may comprise ridges, nubs, bumps, grooves, symbols, or the like along the textured region 266 to form a thumb grip to enhance a user's control during oral care activities. The textured region 266 may comprise horizontally oriented ridges, wavy ridges, or the like in some embodiments. The textured region 266 may comprise elevated structural features to enhance grip thereon. The rigid cover portion 261 may comprise a first or bottom end 267 and a second or top end 268. The textured region 266 may be located between the opening 265 and the second or top end 268.

The elastomeric actuation portion 262 may be coupled to the rigid cover portion 261 to close the opening 265. The elastomeric actuation portion 262 may be formed from an elastomeric material as mentioned above, such as a thermoplastic elastomer, a rubber, a silicone, or other similar flexible materials. The elastomeric actuation portion 262 may be injection molded directly onto the rigid cover portion 261 to facilitate the attachment of the elastomeric actuation portion 262 to the rigid cover portion 261. In some embodiments, bonding materials such as adhesives or alternatively fasteners may be used to secure the attachment of the elastomeric actuation portion 262 to the rigid cover portion 261.

The elastomeric actuation portion 262 is coupled or attached or bonded to the rigid cover portion 261 to form the cover member 260. The cover member 260 may then be bonded, attached, or coupled to the second axial portion 232 of the rigid body portion 230 of the gripping portion 110 of the handle 100. In an embodiment, the cover member 260 may be welded, such as being ultrasonically welded, to the second axial portion 232 of the rigid body portion 230 to facilitate the attachment of the cover member 260 to the rigid body portion 230. The rigid cover portion 261 of the cover member 260 and the rigid body portion 230 may also have mating features, such as male/female features, to assist in the attachment of the two parts. The cover member 260 fully closes the front opening 235 in the second axial portion 232 of the rigid body portion 230 to fully enclose the cavity 115, with the exception of the opening in the bottom end 111 which is closed by the end cap 300 as described herein.

In an embodiment, the elastomeric actuation portion 262 may be located in alignment with the switch element 182 of the switch assembly 180 when the handle 100 is fully assembled. The elastomeric actuation portion 262 may be pressed inwardly towards the cavity 115 to alter the switch assembly 180 between an open state whereby the motor 191 is not powered and a closed state whereby the motor 191 is powered. A user may press on different portions of the elastomeric actuation portion 262 to achieve the alteration from the closed to open states and from the open to closed states. For example, a first symbol 269 may be located on a first axial portion of the elastomeric actuation portion 262 and a second symbol 270 may be located on a second axial portion of the elastomeric portion 262. The first symbol 269 is a line and the second symbol 270 is a ring or circle in the exemplified embodiment, but other symbols or indicia may be used. The user may press the elastomeric actuation portion 262 along the first symbol 269 to alter the switch assembly 180 from the open state to the closed state and the user may press the actuation portion 262 along the second symbol 270 to alter the switch assembly 180 from the closed state to the open state.

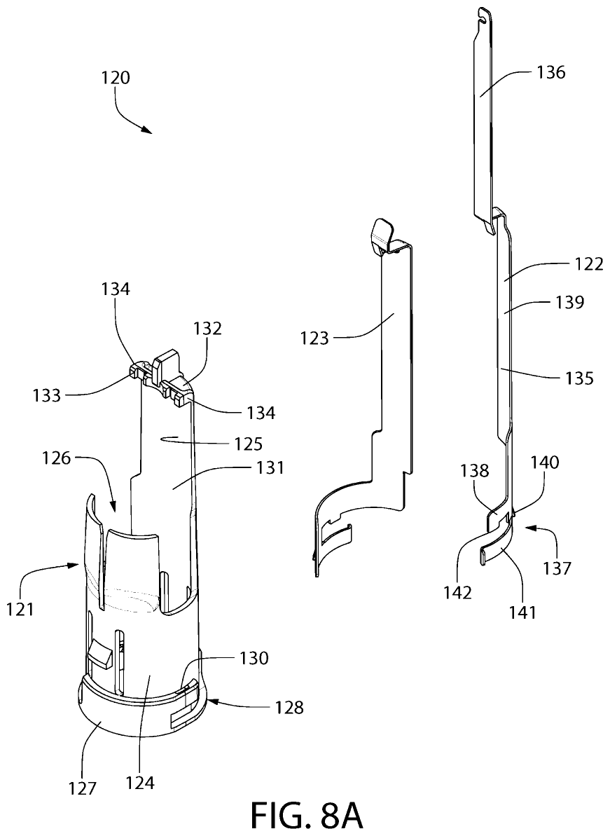

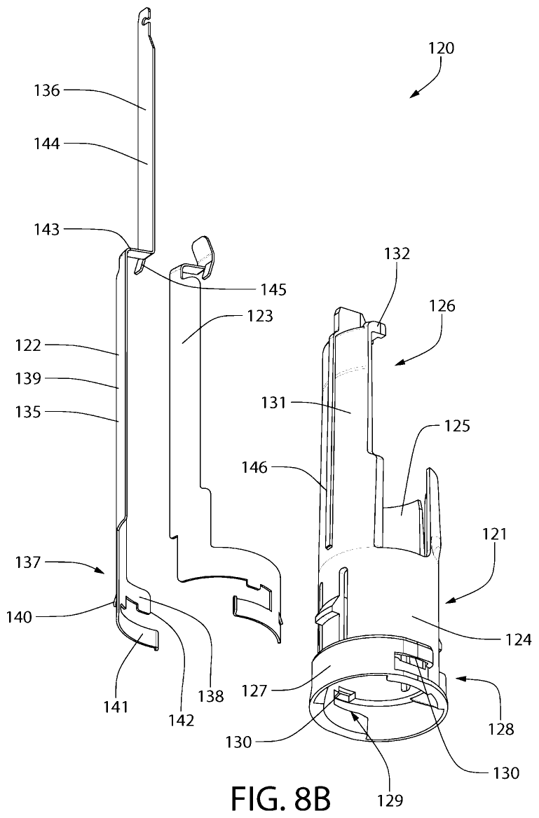

Referring to FIGS. 8A and 8B, the chassis assembly 120 will be further described. The chassis assembly 120 comprises the chassis 121 and the first and second electrical conductor elements 122, 123 as previously described. One of the first and second electrical conductor elements 122, 123 may be omitted in some embodiments. The chassis 121 comprises an outer surface 124 and an inner surface 125. The inner surface 125 of the chassis 121 defines a receptacle 126 within which the battery is disposed in the assembled device. The chassis 121 comprises a lower portion 127 which may comprise a first pair of grooves 128 in the outer surface 124 and a second pair of grooves 129 in the inner surface 125. The chassis 121 may further comprise an aperture 130 that forms a passageway from the outer surface 124 to the inner surface 125.

The chassis 121 may comprise a support wall 131 that extends to a top end of the chassis 121. The support wall 131 provides support for the battery 190 when positioned in the receptacle 126. A support flange 132 may extend inwardly from the distal end of the support wall 131. The support flange 132 may abut an end of the battery 190 when the battery 190 is positioned within the receptacle 126. The support flange 132 may extend from the support wall 131 to a distal surface 133. The distal surface 133 of the support flange 132 may comprise a pair of notches or recesses 134 to assist with the attachment of the first and second electrical conductor elements 122, 123 to the chassis 121. The chassis 121 may be generally sized and shaped to fit into the cavity 115 through the opening 116 in the bottom end 111 of the gripping portion 110 of the handle 100 as described herein.

The first and second electrical conductor elements 122, 123 are metal strips or pieces of shaped metal that are configured to be attached to the chassis 121 and help to transmit or carry power from the battery 190 to the motor 191 and possibly also to a functional feature in the end cap 300. The first electrical conductor element 122 comprises a first portion 135 and a second portion 136. When the first electrical conductor element 122 is coupled to the chassis 121, the first portion 135 extends along the outer surface 124 of the chassis 121 and the second portion 136 protrudes from the top end of the chassis 121.

The first portion 135 of the first electrical conductor element 122 comprises an elongated portion 139 that extends from a bottom end to a top end and a first connection portion 137 that extends perpendicularly from the bottom end of the elongated portion 139. The first connection portion 137 may comprise a first horizontal leg 138 that extends from the bottom end of the elongated portion 139, a vertical leg 140 that extends from an end of the first horizontal leg 138, and a second horizontal leg 141 that extends from an end of the vertical leg 140. The first and second horizontal legs 138, 141 and the vertical leg 140 may be arranged in a U-shape. A protrusion 142 may protrude downwardly from the first horizontal leg 138 in the direction of the second horizontal leg 141 The second horizontal leg 141 may nest within one of the first grooves 128 in the outer surface 124 of the lower portion 127 of the chassis 121 with the protrusion 142 extending through one of the apertures 130 in the chassis 121 to help secure the first electrical conductor element 122 to the chassis 121.

The second portion 136 of the first electrical conductor element 122 may comprise a horizontal portion 143 extending from the second end of the first portion 135 and an elongated portion 144 extending from the opposite end of the horizontal portion 143. A connector tab 145 may extend downwardly from the horizontal portion 143. When the first electrical conductor element 122 is coupled to the chassis 121, the horizontal portion 143 of the second portion 136 may extend over top of the support flange 132 of the chassis 121 and the connector tab 145 may nests within one of the notches 134 in the support flange 132 of the chassis 121.

The second electrical conductor element 123 may have a similar structure to the first electrical conductor element 122 and thus a detailed description thereof will not be provided, it being understood that the description of the first electrical conductor element 122 is generally applicable. However, in this embodiment, the elongated portion of the second electrical conductor element 123 is shorter than the elongated portion 144 of the first electrical conductor element 122. As noted previously, the second electrical conductor element 123 may be altogether omitted in some embodiments whereby its inclusion is not needed to facilitate the coupling between the motor 191 or any other function elements in the powered oral care implement 1000 and the battery 190.

As mentioned above, the first and second electrical conductor elements 122, 123 are coupled to the chassis 121 and are positioned along (or adjacent to or in abutment with) the outer surface 124 of the chassis 121. Thus, in some embodiments the first and second electrical conductor elements 122, 123 do not extend along the inner surface 125 of the chassis 121. The first and second electrical conductor elements 122, 123 may extend along the outer surface of the chassis 121 along the support wall 131 of the chassis 121. The chassis 121 may comprise a dividing rib 146 extending from the outer surface 124 along the support wall 131 to maintain separation between the first and second electrical conductor elements 122, 123. This may be important in some embodiments wherein the first electrical conductor element 122 is electrically coupled to a first terminal of the battery 190 and the second electrical conductor element 123 is electrically coupled to a second terminal of the battery 190. Thus, the dividing rib 146 may ensure that the first and second electrical conductor elements 122, 123 do not contact one another, which could short out the device.

The first and second electrical conductor elements 122, 123 may be coupled to the chassis 121 only via engagement of various structures of the first and second electrical conductor elements 122, 123 and the chassis 121. That is, in an embodiment there may be no fasteners, bonding agents, adhesives, or the like which attach the first and second electrical conductor elements 122, 123 to the chassis 121. The first and second electrical conductor elements 122, 123 may therefore be readily detachable from the chassis 121 when the chassis 121 is removed from the cavity 115 of the gripping portion 110 of the handle 100. This may allow the manufacturer to easily make changes to the first and second electrical conductor elements 122, 123. For example, embodiments described herein show different versions of the second electrical conductor elements 122. The manufacturer may be able to easily swap one for the other depending on the desired functions for the finished product.

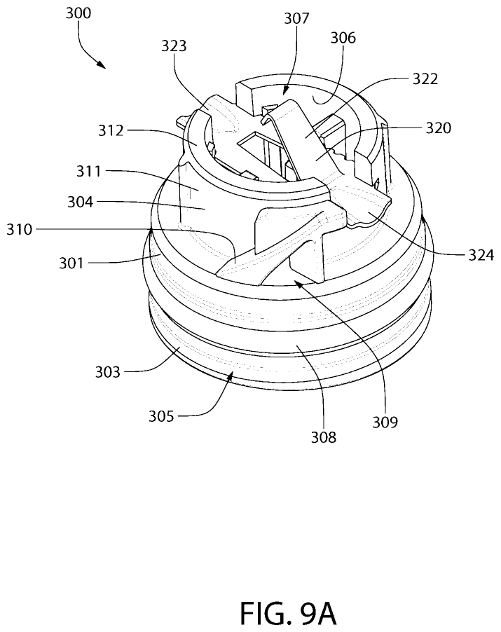

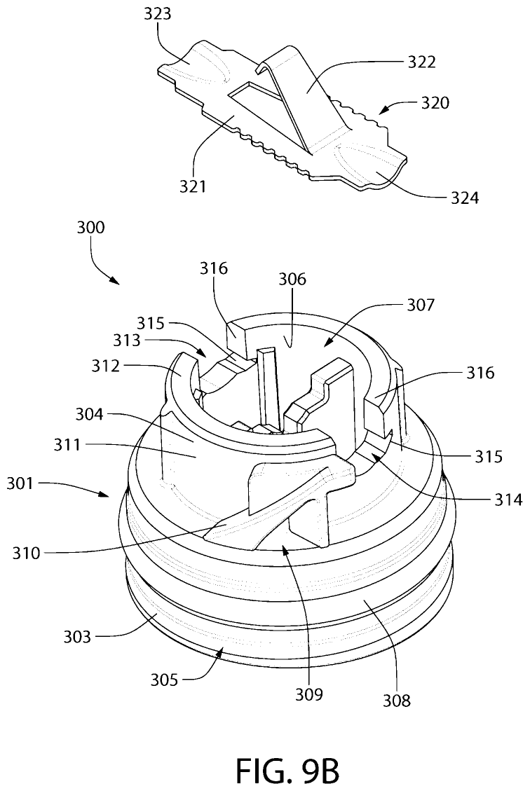

Referring to FIGS. 9A and 9B, the end cap 300 will be described. In this embodiment, the end cap 300 is a non-functional end cap, meaning that the end cap 300 does not contain any electronics, circuitry, sensors, lights, or other functional features which require power for operation. In other embodiments described herein, end caps that include one or more functional elements that require power for operation may be used. In some embodiments, functional and non-functional end caps may be swapped out for one another and used with the same handle 100.

The end cap 300 comprises an end cap housing 301 and a cap contact assembly 320 that is coupled to the end cap housing 301. The end cap housing 301 may be formed from plastic and the cap contact assembly 320 may be formed from an electrically conductive material such as metal. The end cap housing 301 comprises a lower base portion 303 and an upper neck portion 304. The end cap housing 301 further comprises an outer surface 305, and the upper neck portion 304 of the end cap housing 301 comprises an inner surface 306 that defines a cap cavity 307. A gasket 308 may be positioned along the outer surface 305 of the lower base portion 303 of the end cap housing 301 to form a seal with the handle 100 and prevent liquid or debris from entering into the cavity 115 when the end cap 300 is coupled to the handle 100 or to the chassis 120. In the exemplified embodiment the end cap 300 attaches to the chassis 120, but in other embodiments the end cap 300 may attach directly to the handle 100.

The end cap housing 301 comprises a ramp feature 309 located on the outer surface 305 of the upper neck portion 304. The ramp feature 309 is a wall that protrudes from the outer surface 305 and has an upper surface 310 that is angled. The ramp feature 309 assists with expelling the end cap 300 from the cavity 115 when detachment of the end cap 300 from the handle 100 or chassis 120 is desired (for example, to replace the battery 190).

The upper neck portion 304 of the end cap housing 301 comprises an annular sidewall 311 that extends upwardly from the base portion 303 to a distal end 312. A first notch 313 and a second notch 314 are formed into the distal end 312 of the sidewall 311. Each of the notches 313, 314 comprises a pair of undercut regions 315 that exist below a cantilever or overhanging tab 316.

The cap contact assembly 320 comprises a base plate 321, a spring contact element 322, a first cap contact element 323, and a second cap contact element 324. The cap contact assembly 320 may be an integrally formed monolithic component comprising all of the features noted above. The spring contact element 322 may protrude at an angle from an upper surface of the base plate 321. The spring contact element 322 may be configured for direct contact with one of the terminals of the battery 190 to place the cap contact assembly 320 into electrically coupling with the one of the terminals of the battery 190. The spring contact element 322 may be configured to flex upwardly/downwardly relative to the base plate 321 to maintain contact with the battery 190 when assembled. The first cap contact element 323 may extend from (or be an extension of) a first end of the base plate 321 and the second cap contact element 324 may extend from (or be an extension of) a second end of the base plate 321.

The cap contact assembly 320 is coupled to the cap housing 301 such that the first cap contact element 323 nests within the first notch 313 and the second cap contact element 324 nests within the second notch 324. Furthermore, the first cap contact element 323 nests within the undercut regions 315 below the overhanging tabs 316 to hold the cap contact assembly 320 in place and the second cap contact element 324 nests within he undercut regions 315 below the overhanging tabs 316. Portions of the first and second cap contact elements 323, 324 protrude beyond the outer surface 305 of the upper neck portion 304 of the cap housing 301 to facilitate the attachment of the end cap 300 to the chassis 120 or to the handle 100.

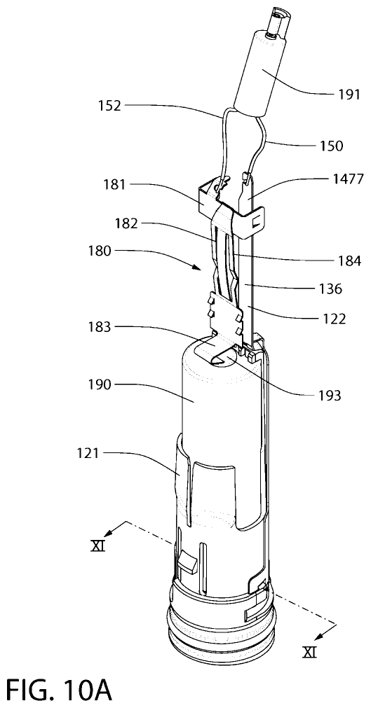

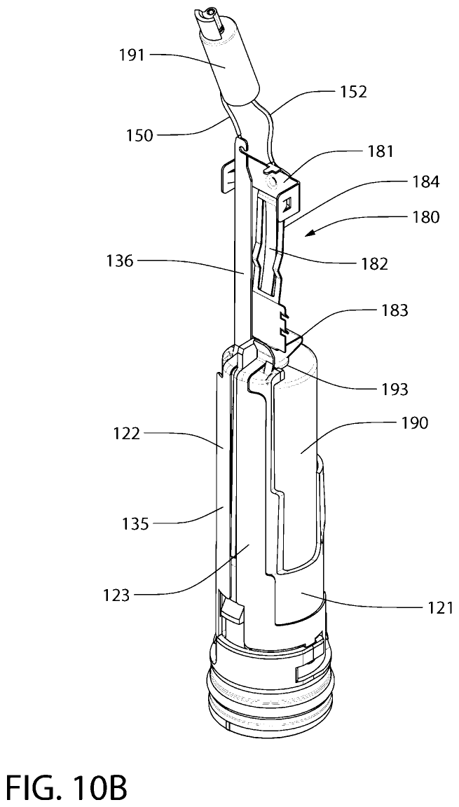

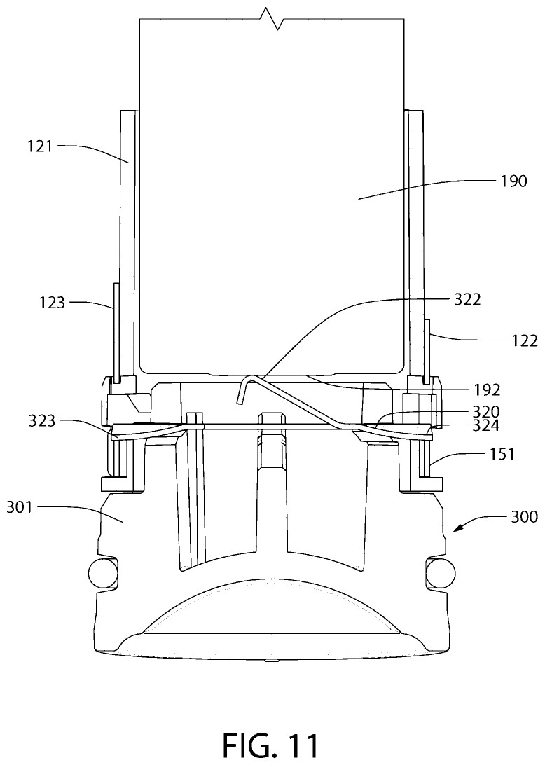

Referring to FIGS. 10A, 10B, and 11 concurrently, additional details regarding the interconnection of the various electronic components of the powered oral care implement 1000 will be described. FIGS. 10A and 10B illustrate the following components in their assembled and attached state, with the handle omitted so that the components are clearly depicted: the end cap 300, the chassis 121, the first and second electrical conductor elements 122, 123, the fixed contact element 181 and the switch element 182 of the switch assembly 180, the motor 191, and the battery 190. FIG. 11 is a cross-sectional view that details the connection between the battery 180 and the cap contact assembly 320 and between the cap contact assembly 320 and the first and second electrical conductor elements 122, 123.

As noted above, the first electrical conductor element 122 comprises a first portion 135 which extends along the outer surface of the chassis 121 and a second portion 136 which protrudes from the top end of the chassis 121. The second portion 136 further comprises a first contact portion 147, which in the exemplified embodiment is formed as a distal portion of the second portion 136. In the exemplified embodiment, a first wire 150 is electrically coupled to the motor 191 and to the first contact portion 147 of the first electrical conductor element 122, which places the first electrical conductor element 122 into electrical coupling with the motor 191. The first wire 150 may be soldered to the first contact portion 147 of the first electrical conductor element 122. Furthermore, as best shown in FIG. 11, the first electrical conductor element 122 comprises a second contact portion 151 that is in contact with the second cap contact element 324 of the cap contact assembly 320. The cap contact assembly 320 is in turn in contact with a first terminal 192 of the battery 190. In particular, the spring contact element 322 of the cap contact assembly 320 is in contact with the first terminal 192 of the battery 190. Thus, the motor 191 is electrically coupled to the first terminal 192 of the battery 190 via the first wire 150, the first electrical conductor element 122, and the cap contact assembly 320. The first terminal 192 may be a positive terminal or a negative terminal, depending on the required orientation of the battery 190 which is not to be limiting of the present invention.

In order to be powered, the motor 191 must also be electrically coupled to a second terminal 193 of the battery 190. As best shown in FIGS. 10A and 10B, a second wire 152 is electrically coupled to the motor 191 and to the fixed contact element 181 of the switch assembly 180. The second wire 152 may be soldered to the fixed contact element 181 of the switch assembly 180 before or after the motor 191 and the fixed contact element 181 are positioned in the cavity 115 of the handle 100. The switch element 182 of the switch assembly 180 comprises a fixed portion 183 and a movable portion 184. The fixed portion 183 of the switch element 182 may be in contact with the second terminal 193 of the battery 190. The movable portion 184 of the switch element 182 is alterable between a first position whereby the movable portion 184 of the switch element 182 is in contact with the fixed contact element 181, as shown in FIGS. 10A and 10B, and a second position whereby the movable portion 184 of the switch element 182 is not in contact with the fixed contact element 181. When the movable portion 184 of the switch element 182 is in the first position, the switch assembly 180 is closed and the motor 191 is electrically coupled to the second terminal 193 of the battery 190 (via connection of the motor 191 to the second wire 152, the second wire 152 to the fixed contact element 181, the fixed contact element 181 to the switch element 182, and the switch element 182 to the second terminal 193 of the battery 190). Thus, when the switch assembly 180 is in the closed state, the motor 191 is powered by the battery 190 and is “on” and when the switch assembly 180 is in the open state, the motor 191 is not powered by the battery 190 and is “off.”

In the exemplified embodiment, the first cap contact element 323 is in contact (and therefore electrically coupled to) the second electrical conductor element 123. However, in this embodiment, the second electrical conductor element 123 is not coupled to any other components. Thus, in some embodiments, the second electrical conductor element 123 may be omitted. In other embodiments, the second electrical conductor element 123 may be electrically coupled to an electronic component to electrically couple such electronic component to the first terminal 192 of the battery 190. The first and second cap contact elements 323, 324 serve as retention features to couple the end cap 300 to the chassis 121, as best seen in FIG. 11.

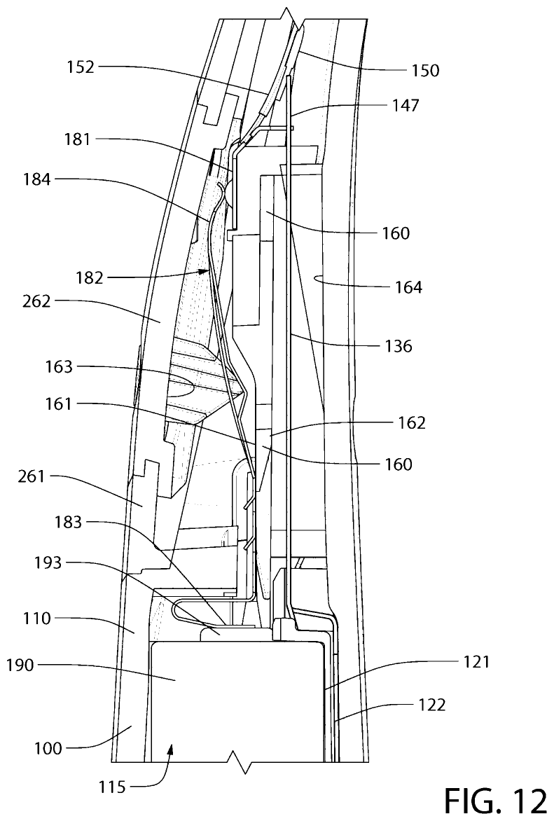

Referring to FIG. FIGS. 7 and 12 concurrently, a distal portion of the second portion 136 of the first electrical conductor element 122, which comprises the first contact portion 147 of the first electrical conductor element 122, extends axially beyond the switch assembly 180. Thus, the first contact portion 147 of the first electrical conductor element 122 is located axially between the switch assembly 180 and the motor 191. Furthermore, the second portion 136 of the first electrical conductor element 122 extends beneath the fixed contact element 181 of the switch assembly 180. In that regard, the handle 100 comprises an insulation element 160 formed integrally with the gripping portion 110 to isolate the switch assembly 180 from the first electrical conductor element 122. The switch assembly 180 is located between a front surface 161 of the insulation element 160 and a front inner surface portion 163 of the gripping portion 110 of the handle 100. The second portion 136 of the first electrical conductor element 122 is located between a rear surface 162 of the insulation element 160 and a rear inner surface portion 164 of the gripping portion 110 of the handle 100.

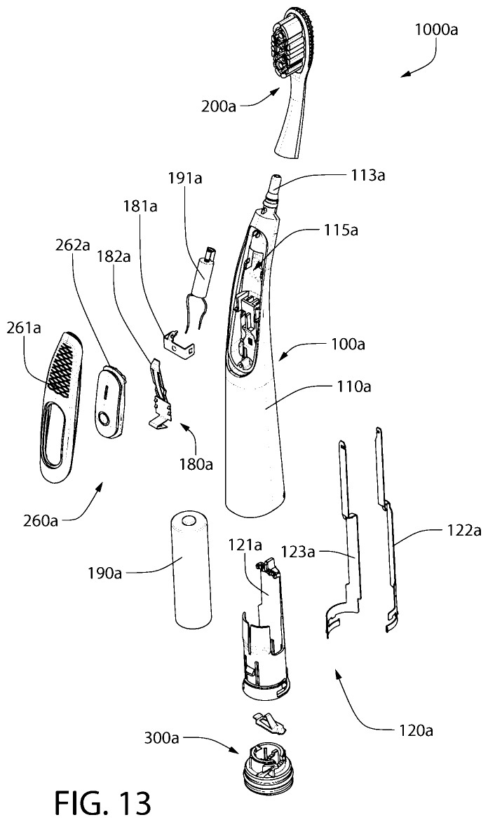

Referring to FIG. 13, the powered oral care implement 1000a is illustrated in accordance with another embodiment. Most of the features of the powered oral care implement 1000a are identical to the powered oral care implement 1000 described above, and will therefore not be described in great detail here in the interest of brevity. Rather, only the features of the powered oral care implement 1000a which differ significantly from the powered oral care implement 1000 will be described in detail. Furthermore, features of the powered oral care implement 1000a which are similar or the same as features of the powered oral care implement 1000 will be similarly numbered, except that the suffix “a” will be used.

Generally, the powered oral care implement 1000a comprises a handle 100a which comprises a gripping portion 110a and a stem 113a and a refill head 200a which is detachably coupled to the stem 113a of the handle 100a. The handle 100a defines a cavity 115a. The gripping portion 110a comprises a rigid body portion 230a and a cover member 260a. The cover member 260a may include a rigid cover portion 261a and an elastomeric actuation portion 262a. The powered oral care implement further comprises several electronic components to facilitate its operation, including a motor 191a, a switch assembly 180a which includes a fixed contact element 181a and a switch element 182a, a chassis assembly 120a which includes a chassis 121a, a first electrical conductor element 122a, and a second electrical conductor element 123a, a battery or other power source 190a, and an end cap 300a. Of the components and parts mentioned, essentially all are identical to those described with reference to the powered oral care implement 1000, except for certain modifications made to the end cap 300a relative to the end cap 300 and certain modifications made to the second electrical conductor element 123a relative to the second electrical conductor element 123.

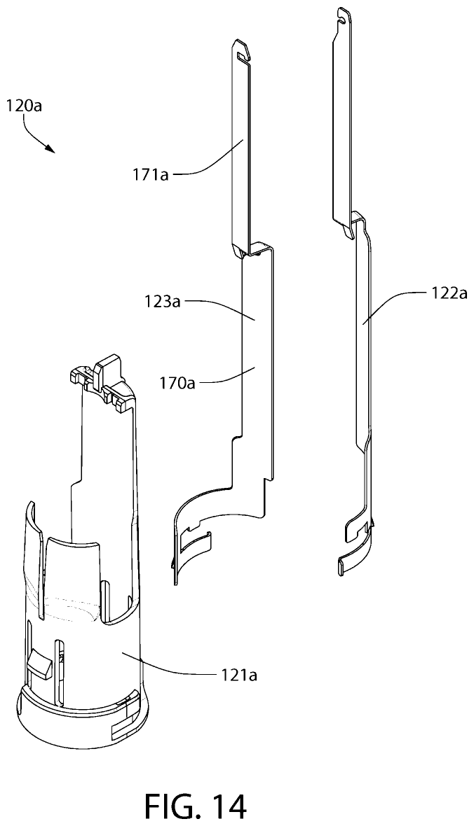

Referring to FIG. 14, the chassis assembly 120a is illustrated in an exploded state with the first and second electrical conductor elements 122a, 123a detached from the chassis 121a. The chassis 121a is identical to the chassis 121 previously described and further details will not be provided herein in the interest of brevity. The first and second electrical conductor elements 122a, 123a are configured to be attached to the chassis 121a to form the chassis assembly 120a, which may then be collectively inserted into the cavity 115a of the handle 100a through the opening in the bottom end of the handle 100a. The first and second electrical conductor elements 122a, 123a are configured for attachment to the outer surface of the chassis 121a such that portions of the first and second electrical conductor elements 122a, 123a extend along the outer surface of the chassis 121a. The first electrical conductor element 122a is identical to the first electrical conductor element 122 previously described, and therefore further details of the first electrical conductor element 122a will not be provided here in the interest of brevity.

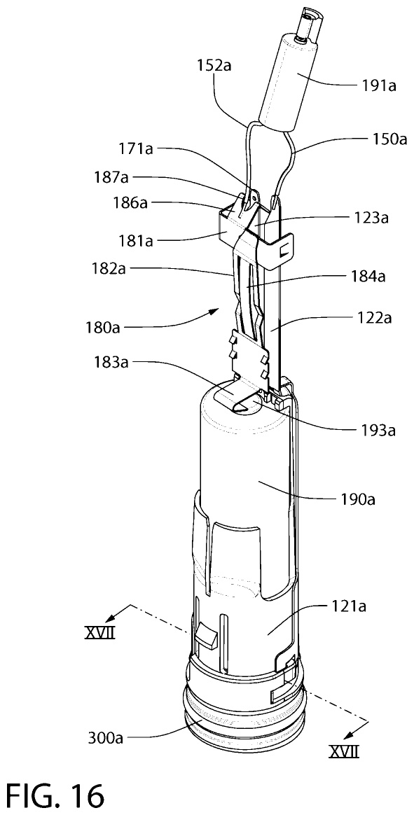

The second electrical conductor element 123a differs slightly from the second electrical conductor element 123 previously described. The second electrical conductor element 123a comprises a first portion 170a that extends along the outer surface of the chassis 121a when coupled thereto and a second portion 171a that protrudes from the top end of the chassis 121a when coupled thereto. Thus, in this embodiment the second electrical conductor element 123a is very similar in structure and length to the first electrical conductor element 122a. The reason for this is that the second electrical conductor element 123a is configured to be in electrical coupling with the second terminal of the battery 190a, which was not the case with the prior embodiment. Further details about this will be provided below with reference to FIG. 16.

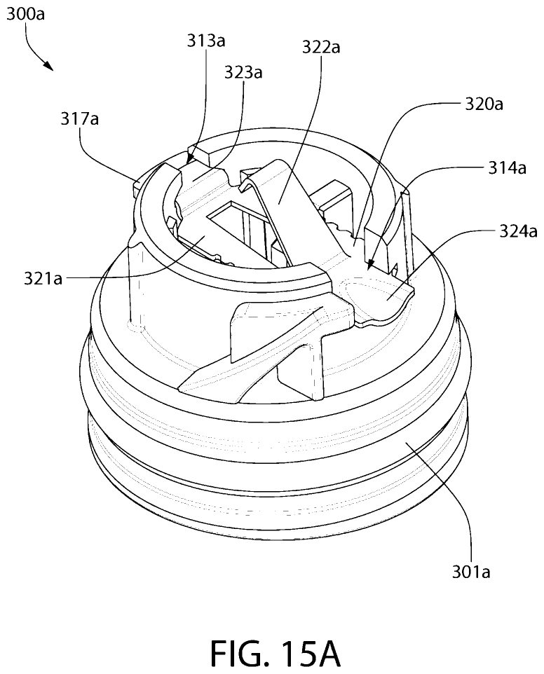

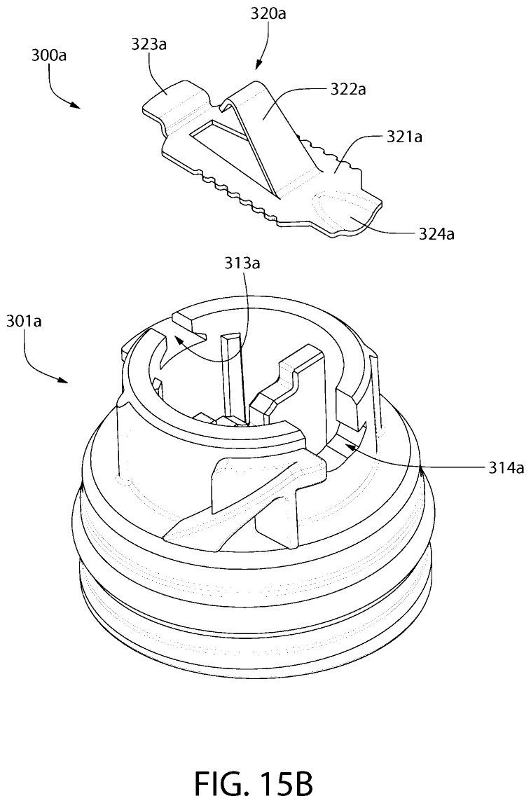

Referring to FIGS. 15A and 15B, the end cap 300a will be described. The end cap 300a generally comprises an end cap housing 301a and a cap contact assembly 320a. The cap contact assembly 320a may be substantially similar to the cap contact assembly 320 previously described. Thus, the cap contact assembly 320a may comprise a base plate 321a, a spring contact element 322a, a first cap contact element 323a, and a second cap contact element 324a. The only distinction between the cap contact assembly 320a and the cap contact assembly 320 is the structure of the first cap contact element 323a. Whereas first cap contact element 323 is planar with the base plate 321, in this embodiment the first cap contact element 323a comprises a vertical portion and a horizontal portion so that the first cap contact element 323a forms a step-like structure. The reason, as will be discussed below, is that the first cap contact element 323a is intentionally configured to not make contact with the second electrical conductor element 123a to avoid shorting out the device.

The end cap housing 301a may be identical to the end cap housing 301 previously described except for the minor distinctions noted here. Specifically, the end cap housing 301a comprises a first notch 313a and a second notch 314a which are structurally equivalent to those same notches of the end cap housing 301. Furthermore, the end cap housing 301a comprises an integrally molded retention tab 317a extending from the outer surface of the end cap housing 301. The integrally molded retention tab 317a may be circumferentially aligned with the first notch 313a and may have an upper surface which is continuous and planar relative to the floor of the first notch 313a.

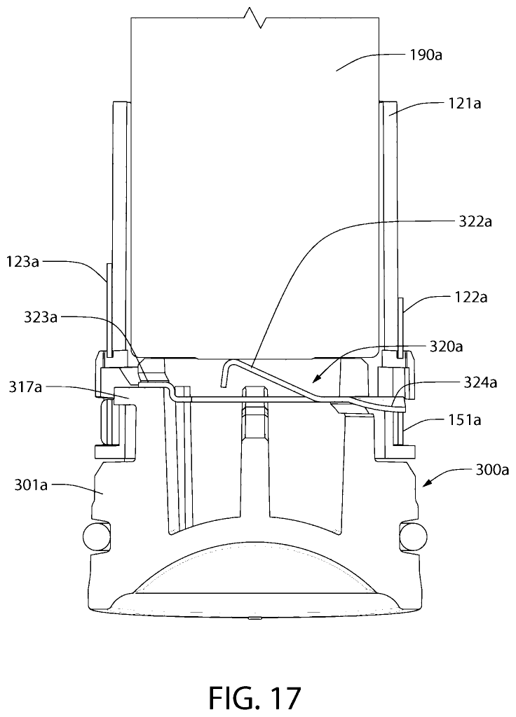

In this embodiment, the first and second cap contact elements 323a, 324a nest within the notches 313a, 314a in the end cap housing 301a to couple the cap contact assembly 320a to the end cap housing 301a. However, in this embodiment the first cap contact element 323a does not protrude beyond the outer surface of the end cap housing 301a. Thus, the first cap contact element 323a does not function to secure the end cap 300a to the handle 100a or chassis 121a, but instead it is the combination of the second cap contact element 324a and the integrally molded retention tab 317a which achieve the coupling function. Furthermore, because the first cap contact element 323a does not protrude radially beyond the outer surface of the end cap housing 301a, the first cap contact element 323a does not contact the second electrical conductor element 123a (best shown in FIG. 17).

Referring now to FIGS. 16 and 17, the various electrical connections between the electronic components will be described. In this embodiment, the fixed contact element 181a of the switch assembly 180a comprises a plate portion 185a and a tab portion 186a that extends obliquely from the plate portion 185a. The tab portion 186a may comprise an aperture 187a. Because the second electrical conductor element 223a is longer than in the prior embodiment, in this embodiment a distal portion of the second electrical conductor element 223a which comprises a first contact portion 171a of the second electrical conductor element 223a extends through the aperture 187a and contacts the tab portion 186a of the fixed contact element 181a of the switch assembly 180a. Of course, the fixed contact element 181a may take other structural forms and in some embodiments the second electrical conductor element 223a may be electrically coupled (or in contact with) the fixed contact element 181a in other ways. In an embodiment the distal portion of the second electrical conductor element 223a may not be soldered to the fixed contact element 181a. Rather, when the chassis assembly 120a is inserted into the cavity 115a, the first contact portion 171a of the second electrical conductor element 223a may end up positioned in contact with the fixed contact element 181a simply during the act of assembly.

As discussed above, the switch element 182a of the switch assembly 180a comprises a fixed portion 183a that is in contact with the second terminal 193a of the battery 190a and a movable portion 184a that extends from the fixed portion 183a. The movable portion 184a is movable between a first position (illustrated in FIG. 16) wherein the movable portion 184a is in contact with the fixed contact element 181a and a second position (not illustrated) wherein the movable portion 184a is not in contact with the fixed contact element 181a. When the movable portion 184a is in the first position, the switch assembly 180a is in a closed state and the motor 191a is electrically coupled to the second terminal 193a of the battery 190a via the second wire 152a which is soldered to the fixed contact element 181a as described above. Furthermore, when the switch assembly 180a is in the closed state, the second electrical conductor element 123a is electrically coupled to the second terminal 193a of the battery 190a due to the contact between the first contact portion 187a of the second electrical conductor element 123a and the fixed contact plate 181a of the switch assembly 180a. The first electrical conductor element 122a is electrically coupled to the motor 191a via the first wire 150a the same as with the prior described embodiment.

Referring to FIG. 11, as with the prior described embodiment, the spring contact element 322a of the cap contact assembly 320a is in contact with and thereby electrically coupled to the first terminal 192a of the battery 190a. The second cap contact element 324a of the cap contact assembly 320a is then in contact with a second contact portion 151a of the first electrical conductor element 122a. As such, the first electrical conductor element 122a is electrically coupled to the first terminal 192a of the battery 190a, which thereby places the motor 191a also into electrical coupling with the first terminal 192a of the battery 190a due to the electrical coupling between the motor 191a and the first electrical conductor element 122a via the wire 150a.

It is noted that the first and second cap contact elements 323a, 324a of the cap contact assembly 320a are both part of an integral conductive structure. Thus, in this embodiment it would not be desirable for the first cap contact element 323a to contact the second electrical conductive element 123a. The reason is that the first cap contact element 323a is electrically coupled to the first terminal 192a of the battery 190a via the spring contact 322a and the second electrical conductive element 123a is electrically coupled to the second terminal 193a of the battery 190a (when the switch assembly 180a is in the closed state). Thus, contact between the first cap contact element 323a and the second electrical conductive element 123a may cause a failure condition.

Thus, in this embodiment, the integrally molded retention tab 317a of the end cap housing 301a, which is preferably formed from plastic, extends from the end cap housing 301a to engage the chassis 121a to perform the coupling function of attaching the end cap 300a to the chassis 121a. The first cap contact element 323a terminates radially inward of the second electrical conductive element 123a so that no contact between the first cap contact element 232a and the second electrical conductive element 123a is possible. In some embodiments, the thickness of the integrally molded retention tab 317a may be increased to prevent a breakage or failure at the point of its extension from the end cap housing outer surface. This may also be remedied by forming the end cap housing 301a out of a strong material, such as glass-filled nylon. In other embodiments, rather than the full notch 313a, there could simply be a channel or slot that receives the first cap contact element 232 which may strengthen the integrally molded retention tab 317a.

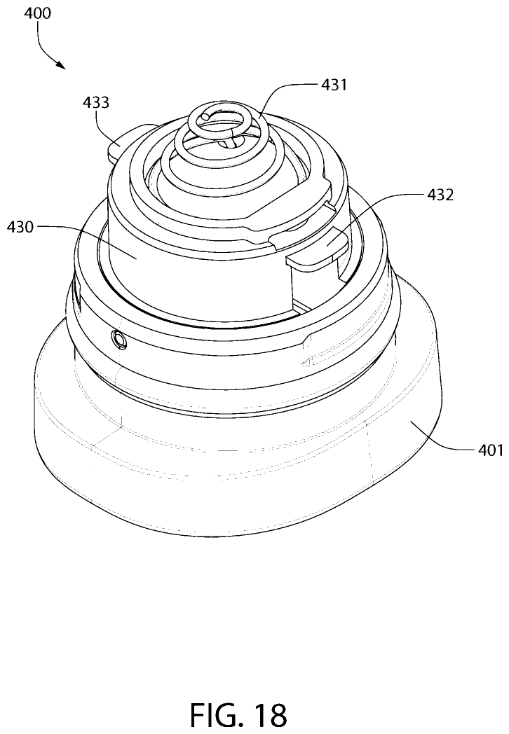

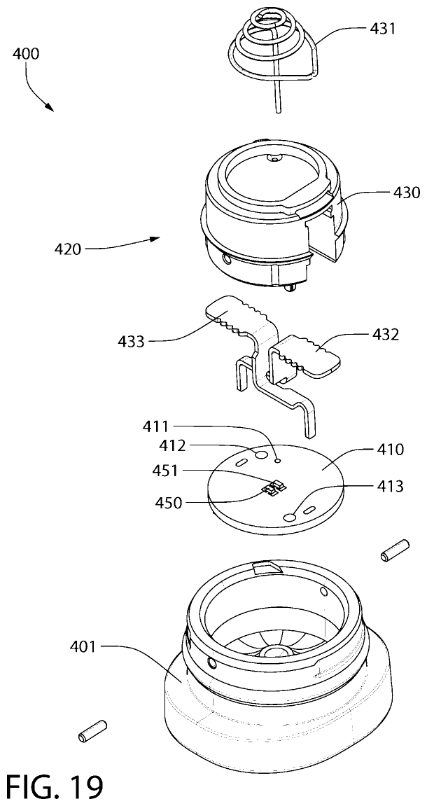

Referring to FIGS. 18 and 19, an end cap 400 is illustrated in accordance with an alternative embodiment of the present invention. In some embodiments, a user may user either the end cap 300a or the end cap 400 with the powered oral care implement 1000a. Thus, the end caps 300a, 400 may be swapped one for the other as desired by the end user. The end cap 300a is a non-functional end cap, meaning it does not contain any functional elements. However, the end cap 400 may be a functional end cap, meaning that it may contain functional elements. Examples of functional elements include, without limitation, illumination elements such as light emitting diodes, sound emitting elements such as speakers, vibration generating elements, timers or timer units, and/or sensors such as accelerometers, gyroscopes, temperature sensors, tracking sensors, position sensors, or the like. The end cap 400 may also include a processor in some embodiments, such that the processor may help to control the operation of the functional element (such as by causing illuminating elements to illuminate at the end of a time period associated with an appropriate amount of time for brushing one's teeth, such as two minutes).

The end cap 400 may comprise an end cap housing 401, a circuit board 410, and a cap contact assembly 420 comprising a contact housing 430, a spring contact element 431, a first cap contact element 432, and a second cap contact element 433. The circuit board 410 may comprise or contain a functional element 450 such as an illuminating element or the like as discussed above. The circuit board 410 may also comprise or contain a processor 451. The circuit board 410 may also comprise or contain a timer which may be part of the processor 451 or a separate component. The circuit board 410 may comprise a first hole 411, a second hole 412, and a third hole 413. The spring contact element 431 may extend into the first hole 411, the first cap contact element 432 may extend into the second hole 412, and the second cap contact element 433 may extend into the third hole 413. Each of the first and second cap contact elements 432, 433 may be electrically coupled to the functional element 450 and to the processor 451 (if any is included) to supply power to the functional element 450 and the processor 451. In an embodiment, the first cap contact element 432 may be operably coupled to the first terminal 192a of the battery 192 and the second cap contact element 433 may be operably coupled to the second terminal 193a of the battery 192. Thus, through their coupling to the functional element 450 and the processor 451, power may be supplied to the functional element 450 and the processor 451.

The first cap contact element 432 may be electrically coupled to the spring contact element 431, either directly or through electrical contacts of the circuit board 410. In an embodiment, the second cap contact element 433 may be electrically isolated from (i.e., not electrically coupled to) the first cap contact element 432 and from the spring contact element 431. When the end cap 400 is fully assembled, portions of the first and second cap contact elements 432, 433 protrude from the outer surface of the contact housing 430 and may help to retain the coupling between the end cap 400 and the handle 100a or chassis 120a.

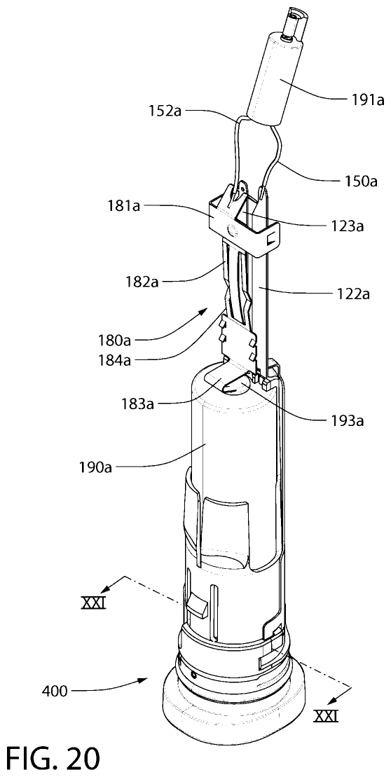

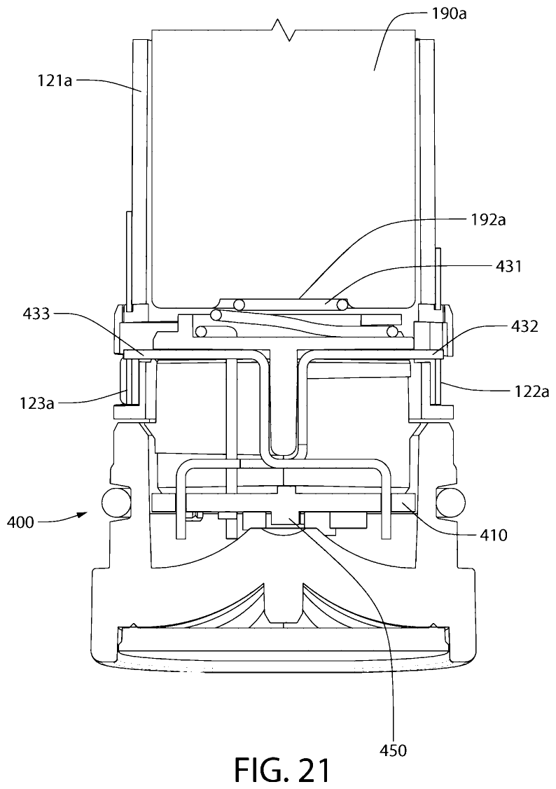

Referring to FIGS. 20 and 21, the manner in which the various components are electrically coupled will be described. FIG. 20 is essentially identical to FIG. 16, except that the end cap 400 is used in place of the end cap 300a. Thus, briefly, when the switch assembly 180a is in the closed state as shown, the second electrical contact element 123a is electrically coupled to the second terminal of the battery 190a via its connection to the switch assembly 180a. Furthermore, the first electrical contact element 122a is electrically coupled to the first terminal 192a of the battery 190a due to its contact with the first cap contact element 432 which is electrically coupled to the spring contact element 431 which is in contact with the first terminal 192a of the battery 190a. Thus, the first electrical contact element 122a is always electrically coupled to the first terminal 192a of the battery 190a. Furthermore, the second electrical contact element 123a is electrically coupled to the second terminal 193 of the battery 190a when the switch assembly 180a is in the closed state.

As noted above, the first and second cap contact elements 432, 433 are electrically coupled to the functional element 450 and any other electronic components of the circuit board 410 of the end cap 400. The first cap contact element 432 is electrically coupled to the first terminal 192a of the battery 190 via the spring contact element 431. The second cap contact element 433 is in contact with the second electrical conductor element 123a, as shown in FIG. 21. When the switch assembly 180a is in the closed state, the second electrical conductor element 123a, and hence also the second cap contact element 433 of the end cap 400, are electrically coupled to the second terminal 193a of the battery 190. Thus, due to the electrical coupling of each of the first and second cap contact elements 432, 433 to the functional element 450, the functional element 450 is electrically coupled to both of the first and second terminals 192a, 193a of the battery 190a when the switch assembly 180 is in the closed state. When the switch assembly 180a is in the open state, the second electrical conductor element 123a and the second cap contact element 433 are not electrically coupled to the second terminal 193a of the battery 190a and the functional element 450 is not powered.

FIG. 24 illustrates the powered oral care implement 1000a with both the end cap 300a and the end cap 400. This is intended to illustrate the either the end cap 300 may be coupled to the handle (or chassis) or the end cap 400 may be coupled to the handle (or chassis), depending on whether the end user wants the functionality that accompanies the end cap 400.

Referring to FIGS. 4-7 concurrently, a method of manufacturing or assembling the powered oral care implement 1000 will be described. First, the handle 100 is formed, such as via an injection molding process. The handle 100 may be formed as a rear part and a front part that are bonded together to define the cavity 115. The handle 100 comprises the gripping portion 110 that extends from the first end 111 to the second end 112 along a longitudinal axis A-A. The gripping portion 110 may comprise the first axial portion 231 that defines the first portion 118 of the cavity 115 and a second axial portion 232 that defines the second portion 119 of the cavity 115, as previously described. The first axial portion 231 may comprise the bottom opening 116 that forms a passageway into the first portion 118 of the cavity 115. The second axial portion 132 may comprise the front opening 235 that forms a passageway into the second portion 119 of the cavity 115.

Once the handle 100 is formed, the next step is to insert the motor 191 into the second portion 119 of the cavity 115 via the front opening 235. The motor 191 may comprise the first wire 150 and the second wire 152. Next, the fixed contact element 181 of the switch assembly 180 may be inserted into the second portion 119 of the cavity 115 via the front opening 235. The fixed contact element 181 may be fixed or attached to interior structure of the gripping portion 110. Next, the switch element 182 of the switch assembly 180 may be inserted into the second portion 119 of the cavity 115 via the front opening 235. The switch element 182 may have a fixed portion 183 that is fixed or attached to interior structure of the gripping portion 110. The switch element 182 may also comprise a movable portion 184 that is movable relative to the fixed portion to open/close the switch assembly.

Next, the chassis assembly 120 may be inserted into the first portion 118 of the cavity 118 through the bottom opening 116. The chassis assembly 120 may comprise the chassis housing 121 and a first electrical conductor element 122 coupled to an outer surface of the chassis housing 121. The chassis assembly 120 may also comprise a second electrical conductor element 123 coupled to the outer surface of the chassis housing 121.

Next, a free end of the second wire 152 may be soldered to the fixed contact element 181 of the switch assembly 180. Next, a free end of the first wire 150 may be soldered to the first electrical conductor element 122. The first wire 150 may be soldered to a distal portion of the first electrical conductor element 122 which may be located adjacent to or near the switch assembly 180.

Next, the cover member 260 may be coupled to the second axial portion 232 of the gripping portion 110 to close the front opening 235. The cover member 260 may be ultrasonically welded to the second axial portion 232 of the gripping portion 110. Finally, the end cap 300, 300a, 400 may be coupled to the handle 100 or to the chassis housing 121 to the close the opening 116 in the first end of the gripping portion. In some embodiments, the end cap 300, 300a, 400 may be attached to the gripping portion 110 before the cover member 260 is attached to the gripping portion 110. In an embodiment, prior to coupling the end cap 300, 300a, 400 to the handle or the chassis housing, the battery 190 may be inserted through the opening 116 in the first end 111 of the gripping portion 110 and into a receptacle 126 defined by the chassis housing 121.

As used throughout, ranges are used as shorthand for describing each and every value that is within the range. Any value within the range can be selected as the terminus of the range. In addition, all references cited herein are hereby incorporated by reference in their entireties. In the event of a conflict in a definition in the present disclosure and that of a cited reference, the present disclosure controls.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

### Exemplary Claim Set

Exemplary 1. A powered oral care implement comprising: a handle comprising a gripping portion having a cavity that extends along a cavity axis from an open bottom end to a top end; a motor in the cavity adjacent to the top end of the cavity; a chassis in the cavity adjacent to the open bottom end of the cavity, the chassis comprising an outer surface and an inner surface that defines a receptacle; a battery configured to be positioned in the receptacle of the chassis; an end cap detachably coupled to the chassis or to the handle to close the open bottom end of the cavity, the end cap comprising a cap contact assembly that is electrically coupled to a first terminal of the battery; a first electrical conductor element coupled to the chassis and extending along the outer surface of the chassis, the first electrical conductor element comprising a first contact portion that is electrically coupled to the motor and a second contact portion that is in contact with the cap contact assembly to electrically couple the motor to the first terminal of the battery; a switch assembly located in the cavity and electrically coupled to a second terminal of the battery, the switch assembly being alterable between: (1) a closed state wherein the switch assembly is electrically coupled to the motor and the motor is powered; and (2) an open state wherein the switch assembly is not electrically coupled to the motor and the motor is not powered; and an actuation assembly on the outer surface of the handle for altering the switch assembly between the open and closed states.

Exemplary 2. The powered oral care implement according to exemplary claim 1 wherein the gripping portion comprises a bottom end and a top end, the handle further comprising a stem protruding from the top end of the gripping portion.

Exemplary 3. The powered oral care implement according to exemplary claim 2 further comprising a refill head detachably coupled to the stem of the handle, wherein the stem is located within a sleeve cavity of the refill head when the refill head is detachably coupled to the stem of the handle.

Exemplary 4. The powered oral care implement according to any one of exemplary claims 1 to 3 further comprising a first wire extending from the motor to the first contact portion of the first electrical conductor element to electrically couple the motor to the first terminal of the battery via the cap contact assembly, the first electrical conductor element, and the first wire.

Exemplary 5. The powered oral care implement according to any one of exemplary claims 1 to 4 further comprising: the switch assembly comprising: a fixed contact element located within the cavity and fixedly coupled to the gripping portion of the handle, the fixed contact element being electrically coupled to the motor by a second wire; and a switch element that is electrically coupled to the second terminal of the battery and alterable between a first position wherein the switch element is in contact with the fixed contact element and the switch assembly is in the closed state and a second position wherein the switch element is not in contact with the fixed contact element and the switch assembly is in the open state.

Exemplary 6. The powered oral care implement according to any one of exemplary claims 1 to 5 wherein the chassis comprises a lower portion, the inner surface of the lower portion comprising a first groove and a second groove, wherein the cap contact assembly comprises a first cap contact element and a second cap contact element that nest within the first and second grooves of the chassis, respectively, to couple the end cap to the chassis.

Exemplary 7. The powered oral care implement according to exemplary claim 6 wherein the lower portion of the chassis comprises an aperture that forms a passageway from the outer surface of the chassis to the first groove, and wherein the first cap contact element extends through the first aperture to contact the second contact portion of the first electrical conductor element to electrically couple the first electrical conductor element with the first terminal of the battery/

Exemplary 8. The powered oral care implement according to any one of exemplary claims 1 to 7 wherein the first electrical conductor element is a metal strip comprising connection features that facilitate the coupling of the first electrical conductor element to the chassis, the first electrical conductor element comprising a first portion that extends along a length of the chassis and a second portion that protrudes from a top end of the chassis, the second portion extending axially within the cavity of the gripping portion of the handle alongside the switch assembly.

Exemplary 9. The powered oral care implement according to exemplary claim 8 wherein a distal portion of the second portion of the first electrical conductor element which comprises the first contact portion of the first electrical conductor element extends axially beyond the switch assembly so that the first contact portion of the first electrical conductor element is located between the switch assembly and the motor in a direction of the cavity axis.

Exemplary 10. The powered oral care implement according to exemplary claim 8 or claim 9 further comprising an insulation element formed integrally with the gripping portion of the handle that isolates the switch assembly from the first electrical conductor element, wherein the switch assembly is located between a front surface of the insulation element and a front inner surface portion of the gripping portion of the handle and the second portion of the first electrical conductor element is located between a rear surface of the insulation element and a rear inner surface portion of the gripping portion of the handle.

Exemplary 11. The powered oral care implement according to any one of exemplary claims 1 to 10 wherein the cap contact assembly of the end cap comprises a spring contact element that contacts the first terminal of the battery, a first cap contact element that is electrically coupled to the spring contact element, and a second cap contact element that is not electrically coupled to the spring contact element, the end cap further comprising a functional element that is electrically coupled to each of the first and second cap contact elements.

Exemplary 12. The powered oral care implement according to exemplary claim 11 further comprising: a second electrical conductor element coupled to the chassis and extending along the outer surface of the chassis, the second electrical conductor element comprising a first contact portion that is electrically coupled to the second terminal of the battery when the switch assembly is in the closed state and a second contact portion that is in contact with the second cap contact element of the cap contact assembly; wherein the second contact portion of the first electrical conductor element is in contact with the first cap contact element of the cap contact assembly to place the first electrical conductor element and the motor into operable coupling with the first terminal of the battery; and wherein the functional element is electrically coupled to the second terminal of the battery when the switch assembly is in the closed state due to the contact between the second cap contact element of the cap contact assembly and the second contact portion of the second electrical conductor element, and wherein the functional element is electrically coupled to the first terminal of the battery due to the contact between the first cap contact element of the cap contact assembly and the spring contact of the cap contact assembly.

Exemplary 13. The powered oral care implement according to exemplary claim 12 wherein the first and second electrical conductor elements are not electrically coupled to one another.

Exemplary 14. The powered oral care implement according to any one of exemplary claims 11 to 13 wherein the end cap comprises a printed circuit board that comprises the functional element and a processor that is configured to control operation of the functional element, and wherein the first and second cap contact elements of the cap contact assembly are electrically coupled to the printed circuit board to supply power from the battery to the processor and the functional element.

Exemplary 15. The powered oral care implement according to exemplary claim 14 wherein the functional element comprises at least one of an illumination element, a sound emitting element, a vibration generating element, or a sensor.

Exemplary 16. A powered oral care implement comprising: a handle comprising a gripping portion having a cavity that extends along a cavity axis from an open bottom end to a top end; a motor in the cavity adjacent to the top end of the cavity; a battery configured to be positioned in the cavity; an end cap configured to close the open bottom end of the cavity of the gripping portion of the handle, the end cap comprising a cap contact assembly that is electrically coupled to a first terminal of the battery, the cap contact assembly comprising a first cap contact element; a switch assembly located in the cavity and electrically coupled to a second terminal of the battery, the switch assembly being alterable between: (1) a closed state wherein the motor is electrically coupled to the second terminal of the battery; and (2) an open state wherein the motor is not electrically coupled to the second terminal of the battery; a first electrical conductor element located in the cavity and comprising a first contact portion that is electrically coupled to the motor and a second contact portion that is electrically coupled to the first terminal of the battery through contact with the first cap contact element of the end cap; and a second electrical conductor element located in the cavity, wherein the second electrical conductor element is electrically coupled to the second terminal of the battery when the switch is in the closed state and the second electrical conductor element is not electrically coupled to the second terminal of the battery when the switch is in the open state.

Exemplary 17. The powered oral care implement according to exemplary claim 16 further comprising an actuation assembly on the outer surface of the handle for altering the switch assembly between the open and closed states.

Exemplary 18. The powered oral care implement according to exemplary claim 16 or exemplary claim 17 further comprising a chassis in the cavity adjacent to the open bottom end of the cavity, the chassis comprising an outer surface and an inner surface that defines a receptacle, wherein the battery is configured to be disposed within the receptacle, and wherein the first and second electrical conductor elements are coupled to the chassis and positioned along the outer surface of the chassis.

Exemplary 19. The powered oral care implement according to exemplary claim 18 wherein the end cap is detachably coupled to the chassis.

Exemplary 20. The powered oral care implement according to any one of exemplary claims 16 to 19 wherein the switch assembly comprises a fixed contact element that is electrically coupled to the motor and a switch element that is electrically coupled to a second terminal of the battery, wherein the switch element is movable between: (1) a first position wherein the switch element is in contact with the fixed contact element to electrically couple the motor to the second terminal of the battery; and (2) a second position wherein the switch element is not in contact with the fixed contact element and the motor is not electrically coupled to the second terminal of the battery.

Exemplary 21. The powered oral care implement according to exemplary claim 20 wherein the second electrical conductor element is coupled to the fixed contact element of the switch assembly so that the second electrical conductor element is only electrically coupled to the second terminal of the battery when the switch element is in the first position.

Exemplary 22. The powered oral care implement according to exemplary claim 20 or exemplary claim 21 wherein the fixed contact element of the switch assembly comprises a plate portion and a tab portion that extends from the plate portion, the tab portion comprising an aperture, and wherein the second electrical conductor element extends through the aperture and contacts the tab portion of the fixed contact element.

Exemplary 23. The powered oral care implement according to any one of exemplary claims 16 to 22 wherein the end cap is non-functional and is not electrically coupled to the second electrical conductor element.

Exemplary 24. The powered oral care implement according to exemplary claim 23 further comprising: a handle assembly comprising the handle; and wherein the end cap comprises an end cap housing comprising outer surface and an integrally molded retention tab protruding from the outer surface, and wherein the first cap contact element of the cap contact assembly protrudes from the outer surface of the end cap housing, and wherein the integrally molded retention tab and the first cap contact element are configured to nest within grooves in the handle assembly to facilitate a coupling between the end cap and the handle assembly.

Exemplary 25. The powered oral care implement according to any one of exemplary claims 16 to 22 wherein the end cap is functional and is electrically coupled to the second electrical conductor element to electrically couple the end cap to the second terminal of the battery when the switch assembly is in the closed state.

Exemplary 26. The powered oral care implement according to exemplary claim 25 wherein the end cap comprises a functional element and a processor that is configured to control operation of the functional element, wherein the functional element comprises at least one of an illumination element, a sound emitting element, a vibration generating element, or a sensor.

Exemplary 27. The powered oral care implement according to exemplary claim 26 wherein the first and second cap contact elements of the cap contact assembly are electrically coupled to the function element and the processor to supply power from the battery to the processor and the functional element.

Exemplary 28. The powered oral care implement according to any one of exemplary claims 16 to 27 further comprising: a chassis in the cavity having an inner surface that defines a receptacle within which the battery is disposed and an outer surface; wherein the first electrical conductor element is a metal strip that is coupled to the chassis, the first electrical conductor element comprising a first portion that extends along the outer surface of the chassis and a second portion that protrudes from a top end of the chassis, the second portion extending axially within the cavity of the gripping portion of the handle towards the motor; and the second electrical conductor element is a metal strip that is coupled to the chassis, the second electrical conductor element comprising a first portion that extends along the outer surface of the chassis and a second portion that protrudes from the top end of the chassis, the second portion extending axially within the cavity of the gripping portion of the handle towards the motor.

Exemplary 29. A powered oral care implement comprising: a handle comprising a gripping portion having a cavity that extends along a cavity axis from an open bottom end to a top end; a motor in the cavity adjacent to the top end of the cavity; a battery configured to be positioned in the cavity; a switch assembly located in the cavity and comprising a fixed contact element that is electrically coupled to the motor and a switch element that is electrically coupled to a second terminal of the battery, the switch element being alterable between: (1) a first position wherein the switch element is in contact with the fixed contact element to electrically couple the motor to the second terminal of the battery; and (2) a second position wherein the switch element is not in contact with the fixed contact element and the motor is not electrically coupled to the second terminal of the battery; a first electrical conductor element located in the cavity and comprising a first contact portion that is electrically coupled to the motor and a second contact portion; a second electrical conductor element located in the cavity and comprising a first contact portion that is electrically coupled to the fixed contact element and a second contact portion; wherein the open bottom end of the cavity is configured to be closed by an end cap selected from a non-functional end cap and a functional end cap, wherein: the non-functional end cap comprises a cap contact assembly that is electrically coupled to a first terminal of the battery and the second contact portion of the first electrical conductor element without being electrically coupled to the second terminal of the battery; and the functional end cap comprises a functional element and a cap contact assembly operably coupled to the functional element, the cap contact assembly comprising a first cap contact element that electrically couples the functional element to the first terminal of the battery and a second cap contact element that is in contact with the second contact portion of the second electrical conductor element to electrically couple the functional element to the second terminal of the battery when the switch element is in the first position to power the functional element.

Exemplary 30. The powered oral care implement according to exemplary claim 29 wherein for the functional end cap, the first cap contact element of the cap contact assembly is in contact with the second contact portion of the first electrical conductor element to electrically couple the motor to the first terminal of the battery.

Exemplary 31. The powered oral care implement according to exemplary claim 29 or exemplary claim 30 wherein for the functional end cap, the first cap contact element is not electrically coupled to the second cap contact element.

Exemplary 32. The powered oral care implement according to any one of exemplary claims 29 to 31 wherein the cap contact assembly of the non-functional end cap is not electrically coupled to the second electrical conductor element or the second terminal of the battery.

Exemplary 33. The powered oral care implement according to any one of exemplary claims 29 to 32 further comprising an actuation assembly on the outer surface of the handle for altering the switch element between the first and second positions.

Exemplary 34. The powered oral care implement according to any one of exemplary claims 29 to 33 further comprising: a chassis in the cavity having an inner surface that defines a receptacle within which the battery is disposed and an outer surface; wherein the first electrical conductor element is a metal strip that is coupled to the chassis and positioned along the outer surface of the chassis; and wherein the second electrical conductor element is a metal strip that is coupled to the chassis and positioned along the outer surface of the chassis.

Exemplary 35. The powered oral care implement according to exemplary claim 34 further comprising: the first electrical conductor element comprising a first portion that extends along the outer surface of the chassis and a second portion that protrudes from a top end of the chassis, the second portion extending axially within the cavity of the gripping portion of the handle towards the motor; and the second electrical conductor element comprising a first portion that extends along the outer surface of the chassis and a second portion that protrudes from the top end of the chassis, the second portion extending axially within the cavity of the gripping portion of the handle towards the motor.

Exemplary 36. A powered oral care implement comprising: a handle assembly comprising a handle comprising a gripping portion having a cavity that extends along a cavity axis from an open bottom end to a top end; a motor in the cavity adjacent to the top end of the cavity; a battery configured to be positioned in the cavity; a switch assembly located in the cavity and electrically coupled to a second terminal of the battery, the switch assembly being alterable between: (1) a closed state wherein the motor is electrically coupled to the second terminal of the battery; and (2) an open state wherein the motor is not electrically coupled to the second terminal of the battery; a first electrical conductor element located in the cavity and comprising a first contact portion that is electrically coupled to the motor and a second contact portion; and a non-functional end cap configured to close the open bottom end of the cavity, the non-functional end cap comprising: a cap housing comprising a sidewall and a retention element protruding radially outward form the sidewall; and a cap contact assembly coupled to the cap housing, the cap contact assembly comprising a spring contact element that is coupled to a first terminal of the battery and a first cap contact element protruding radially outward from the sidewall of the cap housing; and wherein the retention element and the first cap contact element are configured to engage the handle assembly to couple the non-functional end cap to the handle assembly, and wherein the first cap contact element is in contact with the second contact portion of the first electrical conductor element when the non-functional end cap is coupled to the handle assembly to electrically couple the motor to the first terminal of the battery.

Exemplary 37. The powered oral care implement according to exemplary claim 36 wherein the handle assembly comprises a chassis located in the cavity of the gripping portion of the handle, the chassis comprising an inner surface that defines a receptacle within which the battery is disposed and an outer surface, wherein the first electrical conductor element is coupled to the chassis and extends along the outer surface of the chassis, and wherein the non-functional end cap is configured for detachable coupling to the chassis.

Exemplary 38. A powered oral care implement comprising: a handle assembly comprising a handle comprising a gripping portion having a cavity that extends along a cavity axis from an open bottom end to a top end; a motor in the cavity adjacent to the top end of the cavity; a battery configured to be positioned in the cavity; a switch assembly located in the cavity and electrically coupled to a second terminal of the battery, the switch assembly being alterable between: (1) a closed state wherein the motor is electrically coupled to the second terminal of the battery; and (2) an open state wherein the motor is not electrically coupled to the second terminal of the battery; a first electrical conductor element located in the cavity and comprising a first contact portion that is electrically coupled to the motor and a second contact portion; a second electrical conductor element located in the cavity and comprising a first contact portion that is coupled to the switch assembly and a second contact portion; a functional end cap configured to close the open bottom end of the cavity, the functional end cap comprising: a functional element configured to perform a function when powered; a cap housing; and a cap contact assembly coupled to the cap housing, the cap contact assembly comprising: a first cap contact element that is electrically coupled to a first terminal of the battery and is in contact with the second contact portion of the first electrical conductor element to electrically couple the motor to the first terminal of the battery; and a second cap contact element that is in contact with the second contact portion of the second electrical conductor element; and wherein the first and second cap contact elements are electrically coupled to the functional element so that the functional element is powered when the switch assembly is in the closed state.

Exemplary 39. The powered oral care implement according to exemplary claim 38 wherein the handle assembly comprises a chassis located in the cavity of the gripping portion of the handle, the chassis comprising an inner surface that defines a receptacle within which the battery is disposed and an outer surface, wherein the first and second electrical conductor elements are coupled to the chassis and extend along the outer surface of the chassis, and wherein the non-functional end cap is configured for detachable coupling to the chassis.

Exemplary 40. A powered oral care implement comprising: a handle comprising a gripping portion that extends from a first end to a second end along a longitudinal axis, the gripping portion comprising: a rigid body portion defining a cavity, the rigid body portion comprising: a first axial portion comprising a body that surrounds a first portion of the cavity, the first axial portion comprising the first end of the gripping portion; and a second axial portion that extends from the first axial portion to the second end of the gripping portion, the second axial portion comprising a front opening that forms a passageway into a second portion of the cavity; a cover member bonded to the rigid body portion to close the front opening, the cover member comprising: a rigid cover portion comprising a front surface, a rear surface, and an opening extending from the front surface to the rear surface; and an elastomeric actuation portion coupled to the rigid cover portion to close the opening in the rigid cover portion; a motor, a power source, and a switch located in the cavity, wherein actuation of the elastomeric actuation portion of the cover member actuates the switch between an open state whereby the motor is not electrically coupled to the power source and an closed state whereby the motor is electrically coupled to the power source.

Exemplary 41. The powered oral care implement according to exemplary claim 40 wherein the rigid body portion is and the rigid cover portion are formed from a hard plastic material, and wherein the elastomeric actuation portion is formed from an elastomeric material.

Exemplary 42. The powered oral care implement according to exemplary claim 40 or exemplary claim 41 wherein the rigid cover portion is welded to the second axial portion of the rigid body portion to close the front opening of the second axial portion.

Exemplary 43. The powered oral care implement according to any one of exemplary claims 40 to 42 wherein the switch and the motor are located within the second portion of the cavity, and wherein the power source is located within the first portion of the cavity.

Exemplary 44. The powered oral care implement according to exemplary claim 43 further comprising a chassis located within the first portion of the cavity, the chassis comprising an inner surface that defines a receptacle and an outer surface opposite the inner surface, and wherein the power source is a battery that is located within the receptacle of the chassis.

Exemplary 45. The powered oral care implement according to exemplary claim 44 further comprising a first electrical conductor element coupled to the outer surface of the chassis, the first electrical conductor element being electrically coupled to the motor and to a first terminal of the battery, and wherein the switch is coupled to a second terminal of the battery.

Exemplary 46. The powered oral care implement according to any one of exemplary claims 40 to 45 wherein the front opening in the second axial portion of the rigid body is elongated in a direction of the longitudinal axis.

Exemplary 47. The powered oral care implement according to any one of exemplary claims 40 to 46 wherein the second axial portion of the rigid body portion has a second length, and wherein the front opening extends along greater than 70% of the second length.

Exemplary 48. The powered oral care implement according to exemplary claim 47 wherein the front opening extends along greater than 90% of the second length.

Exemplary 49. The powered oral care implement according to any one of exemplary claims 40 to 48 wherein the gripping portion of the handle has a length, and wherein the front opening extends along between 40% and 60% of the length.

Exemplary 50. The powered oral care implement according to any one of exemplary claims 40 to 49 wherein the front surface of the rigid cover portion comprises a textured region.

Exemplary 51. The powered oral care implement according to exemplary claim 50 wherein the rigid cover portion comprises ridges on the front surface along the textured region.

Exemplary 52. The powered oral care implement according to exemplary claim 50 or exemplary claim 51 wherein the textured region is located between the elastomeric actuation portion and the second end of the gripping portion.

Exemplary 53. The powered oral care implement according to any one of exemplary claims 40 to 52 wherein the handle comprises a stem portion that extends from the second end of the gripping portion.

Exemplary 54. The powered oral care implement according to exemplary claim 53 further comprising a refill head comprising a head portion having tooth cleaning elements and a sleeve portion that having an inner surface that defines a sleeve cavity, wherein the refill head is detachably coupled to the handle via engagement between the stem portion of the handle and connection features located on the inner surface of the sleeve portion of the refill head.

Exemplary 55. The powered oral care implement according to any one of exemplary claims 40 to 54 wherein the gripping portion of the handle comprises a bottom opening located at the first end of the gripping portion.

Exemplary 56. The powered oral care implement according to exemplary claim 55 further comprising an end cap configured to close the bottom opening of the gripping portion of the handle.

Exemplary 57. The powered oral care implement according to exemplary claim 55 or exemplary claim 56 wherein the motor and the switch are inserted into the cavity through the front opening in the second axial portion of the rigid body portion prior to bonding the cover portion to the rigid body portion, and wherein the power source is inserted into the cavity through the bottom opening.

Exemplary 58. The powered oral care implement according to any one of exemplary claims 40 to 57 wherein the body of the first axial portion of the rigid body portion comprises an inner surface that defines the first portion of the cavity and an outer surface opposite the inner surface, and wherein the body of the first axial portion of the rigid body portion is free of any openings that extend from the outer surface to the inner surface.

Exemplary 59. A method of manufacturing a powered oral care implement, the method comprising: forming a handle comprising a gripping portion that extends from a first end to a second end along a longitudinal axis, the gripping portion comprising: a first axial portion defining a first portion of a cavity, the first axial portion comprising a bottom opening that forms a passageway into the first portion of the cavity; and a second axial portion defining a second portion of the cavity, the second axial portion comprising a front opening that forms a passageway into the second portion of the cavity; inserting a motor into the second portion of the cavity via the front opening, the motor comprising a first wire and a second wire; inserting a fixed contact element of a switch assembly into the second portion of the cavity via the front opening and attaching the fixed contact element to the gripping portion; inserting a switch element of the switch assembly into the second portion of the cavity via the front opening and attaching the switch element to the gripping portion; inserting a chassis assembly into the first portion of the cavity through the bottom opening of the first axial portion of the gripping portion, the chassis assembly comprising a chassis housing and a first electrical conductor element coupled to an outer surface of the chassis housing; soldering a free end of the first wire to the first electrical conductor element; and soldering a free end of the second wire to the fixed contact element of the switch assembly.

Exemplary 60. The method according to exemplary claim 59 further comprising attaching a cover member to the second axial portion of the gripping portion to close the front opening.

Exemplary 61. The method according to exemplary claim 62 wherein the cover member is ultrasonically welded to the second axial portion of the gripping portion.

Exemplary 62. The method according to any one of exemplary claims 59 to 61 further comprising coupling an end cap to the handle or to the chassis housing to the close the opening in the first end of the gripping portion.

Exemplary 63. The method according to any one of exemplary claims 59 to 62 further comprising, prior to coupling the end cap to the handle or the chassis housing, inserting a battery through the opening in the first end of the gripping portion and into a receptacle defined by the chassis housing.

1. A powered oral care implement comprising:
a handle comprising a gripping portion having a cavity that extends along a cavity axis from an open bottom end to a top end;
a motor in the cavity adjacent to the top end of the cavity;
a chassis in the cavity adjacent to the open bottom end of the cavity, the chassis comprising an outer surface and an inner surface that defines a receptacle;
a battery configured to be positioned in the receptacle of the chassis;
an end cap detachably coupled to the chassis or to the handle to close the open bottom end of the cavity, the end cap comprising a cap contact assembly that is electrically coupled to a first terminal of the battery;
a first electrical conductor element coupled to the chassis and extending along the outer surface of the chassis, the first electrical conductor element comprising a first contact portion that is electrically coupled to the motor and a second contact portion that is in contact with the cap contact assembly to electrically couple the motor to the first terminal of the battery;
a switch assembly located in the cavity and electrically coupled to a second terminal of the battery, the switch assembly being alterable between: (1) a closed state wherein the switch assembly is electrically coupled to the motor and the motor is powered; and (2) an open state wherein the switch assembly is not electrically coupled to the motor and the motor is not powered; and
an actuation assembly on the outer surface of the handle for altering the switch assembly between the open and closed states.

2. The powered oral care implement according to claim 1 further comprising a first wire extending from the motor to the first contact portion of the first electrical conductor element to electrically couple the motor to the first terminal of the battery via the cap contact assembly, the first electrical conductor element, and the first wire.

3. The powered oral care implement according to claim 1 further comprising:
the switch assembly comprising:
a fixed contact element located within the cavity and fixedly coupled to the gripping portion of the handle, the fixed contact element being electrically coupled to the motor by a second wire; and
a switch element that is electrically coupled to the second terminal of the battery and alterable between a first position wherein the switch element is in contact with the fixed contact element and the switch assembly is in the closed state and a second position wherein the switch element is not in contact with the fixed contact element and the switch assembly is in the open state.

4. The powered oral care implement according to claim 1 wherein the first electrical conductor element is a metal strip comprising connection features that facilitate the coupling of the first electrical conductor element to the chassis, the first electrical conductor element comprising a first portion that extends along a length of the chassis and a second portion that protrudes from a top end of the chassis, the second portion extending axially within the cavity of the gripping portion of the handle alongside the switch assembly.

5. The powered oral care implement according to claim 4 wherein a distal portion of the second portion of the first electrical conductor element which comprises the first contact portion of the first electrical conductor element extends axially beyond the switch assembly so that the first contact portion of the first electrical conductor element is located between the switch assembly and the motor in a direction of the cavity axis.

6. The powered oral care implement according to claim 4 further comprising an insulation element formed integrally with the gripping portion of the handle that isolates the switch assembly from the first electrical conductor element, wherein the switch assembly is located between a front surface of the insulation element and a front inner surface portion of the gripping portion of the handle and the second portion of the first electrical conductor element is located between a rear surface of the insulation element and a rear inner surface portion of the gripping portion of the handle.

7. The powered oral care implement according to claim 1 wherein the cap contact assembly of the end cap comprises a spring contact element that contacts the first terminal of the battery, a first cap contact element that is electrically coupled to the spring contact element, and a second cap contact element that is not electrically coupled to the spring contact element, the end cap further comprising a functional element that is electrically coupled to each of the first and second cap contact elements.

8. The powered oral care implement according to claim 7 further comprising:
a second electrical conductor element coupled to the chassis and extending along the outer surface of the chassis, the second electrical conductor element comprising a first contact portion that is electrically coupled to the second terminal of the battery when the switch assembly is in the closed state and a second contact portion that is in contact with the second cap contact element of the cap contact assembly;
wherein the second contact portion of the first electrical conductor element is in contact with the first cap contact element of the cap contact assembly to place the first electrical conductor element and the motor into operable coupling with the first terminal of the battery; and
wherein the functional element is electrically coupled to the second terminal of the battery when the switch assembly is in the closed state due to the contact between the second cap contact element of the cap contact assembly and the second contact portion of the second electrical conductor element, and wherein the functional element is electrically coupled to the first terminal of the battery due to the contact between the first cap contact element of the cap contact assembly and the spring contact of the cap contact assembly.

9. The powered oral care implement according to claim 7 wherein the end cap comprises a printed circuit board that comprises the functional element and a processor that is configured to control operation of the functional element, and wherein the first and second cap contact elements of the cap contact assembly are electrically coupled to the printed circuit board to supply power from the battery to the processor and the functional element, wherein the functional element comprises at least one of an illumination element, a sound emitting element, a vibration generating element, a timer, or a sensor.

10. A powered oral care implement comprising:
a handle comprising a gripping portion having a cavity that extends along a cavity axis from an open bottom end to a top end;
a motor in the cavity adjacent to the top end of the cavity;
a battery configured to be positioned in the cavity;
a switch assembly located in the cavity and comprising a fixed contact element that is electrically coupled to the motor and a switch element that is electrically coupled to a second terminal of the battery, the switch element being alterable between: (1) a first position wherein the switch element is in contact with the fixed contact element to electrically couple the motor to the second terminal of the battery; and (2) a second position wherein the switch element is not in contact with the fixed contact element and the motor is not electrically coupled to the second terminal of the battery;
a first electrical conductor element located in the cavity and comprising a first contact portion that is electrically coupled to the motor and a second contact portion;
a second electrical conductor element located in the cavity and comprising a first contact portion that is electrically coupled to the fixed contact element and a second contact portion;
wherein the open bottom end of the cavity is configured to be closed by an end cap, wherein the end cap is one of a non-functional end cap and a functional end cap, wherein:
the non-functional end cap comprises a cap contact assembly that is electrically coupled to a first terminal of the battery and the second contact portion of the first electrical conductor element without being electrically coupled to the second terminal of the battery; and
the functional end cap comprises a functional element and a cap contact assembly operably coupled to the functional element, the cap contact assembly comprising a first cap contact element that electrically couples the functional element to the first terminal of the battery and a second cap contact element that is in contact with the second contact portion of the second electrical conductor element to electrically couple the functional element to the second terminal of the battery when the switch element is in the first position to power the functional element.

11. The powered oral care implement according to claim 10 wherein for the functional end cap, the first cap contact element of the cap contact assembly is in contact with the second contact portion of the first electrical conductor element to electrically couple the motor to the first terminal of the battery.

12. The powered oral care implement according to claim 1 wherein the cap contact assembly of the non-functional end cap is not electrically coupled to the second electrical conductor element or the second terminal of the battery.

13. The powered oral care implement according to claim 10 further comprising:
a chassis in the cavity having an inner surface that defines a receptacle within which the battery is disposed and an outer surface;
wherein the first electrical conductor element is a metal strip that is coupled to the chassis and positioned along the outer surface of the chassis; and
wherein the second electrical conductor element is a metal strip that is coupled to the chassis and positioned along the outer surface of the chassis.

14. The powered oral care implement according to claim 13 further comprising:
the first electrical conductor element comprising a first portion that extends along the outer surface of the chassis and a second portion that protrudes from a top end of the chassis, the second portion extending axially within the cavity of the gripping portion of the handle towards the motor; and
the second electrical conductor element comprising a first portion that extends along the outer surface of the chassis and a second portion that protrudes from the top end of the chassis, the second portion extending axially within the cavity of the gripping portion of the handle towards the motor.

15. A powered oral care implement comprising:
a handle assembly comprising a handle comprising a gripping portion having a cavity that extends along a cavity axis from an open bottom end to a top end;
a motor in the cavity adjacent to the top end of the cavity;
a battery configured to be positioned in the cavity;
a switch assembly located in the cavity and electrically coupled to a second terminal of the battery, the switch assembly being alterable between: (1) a closed state wherein the motor is electrically coupled to the second terminal of the battery; and (2) an open state wherein the motor is not electrically coupled to the second terminal of the battery;
a first electrical conductor element located in the cavity and comprising a first contact portion that is electrically coupled to the motor and a second contact portion; and
a non-functional end cap configured to close the open bottom end of the cavity, the non-functional end cap comprising:
a cap housing comprising a sidewall and a retention element protruding radially outward form the sidewall; and
a cap contact assembly coupled to the cap housing, the cap contact assembly comprising a spring contact element that is coupled to a first terminal of the battery and a first cap contact element protruding radially outward from the sidewall of the cap housing; and
wherein the retention element and the first cap contact element are configured to engage the handle assembly to couple the non-functional end cap to the handle assembly, and wherein the first cap contact element is in contact with the second contact portion of the first electrical conductor element when the non-functional end cap is coupled to the handle assembly to electrically couple the motor to the first terminal of the battery.

16. The powered oral care implement according to claim 15 wherein the handle assembly comprises a chassis located in the cavity of the gripping portion of the handle, the chassis comprising an inner surface that defines a receptacle within which the battery is disposed and an outer surface, wherein the first electrical conductor element is coupled to the chassis and extends along the outer surface of the chassis, and wherein the non-functional end cap is configured for detachable coupling to the chassis.

17.-34. (canceled)
